(19) United States
(12) Patent Application Publication
(10) Pub. No.: US 2025/0358088 A1
(43) Pub. Date: Nov. 20, 2025

(54) ELECTRONIC DEVICE COMPRISING MEMORY FOR UPLINK AND DOWNLINK

(71) Applicant: Samsung Electronics Co., Ltd., Suwon-si (KR)

(72) Inventors: Kyoung HEO, Suwon-si (KR); Wooyeon KIM, Suwon-si (KR); Sungwon KO, Suwon-si (KR)

(21) Appl. No.: 19/288,195

(22) Filed: Aug. 1, 2025

Related U.S. Application Data
(63) Continuation of application No. PCT/KR2023/020144, filed on Dec. 7, 2023.

(30) Foreign Application Priority Data
Feb. 3, 2023 (KR) 10-2023-0015175
Mar. 13, 2023 (KR) 10-2023-0032332
Mar. 24, 2023 (KR) 10-2023-0038931

(51) Int. Cl. H04L 5/14; H04B 1/00

(52) U.S. Cl. CPC H04L 5/143; H04B 1/0057; H04L 5/1461

(57) ABSTRACT

An electronic device comprises: a memory for processing DL and UL samples, wherein the memory stores first to third sample data for first to third symbols, respectively, within a designated time interval, the first sample data including input data for FFT for the first symbol, the second sample data including output data for IFFT for the second symbol, and the third sample data including either input data for FFT or output data for IFFT for the third symbol.

### CROSS-REFERENCE TO RELATED APPLICATIONS

This application is a continuation of International Application No. PCT/KR2023/020144 designating the United States, filed on Dec. 7, 2023, in the Korean Intellectual Property Receiving Office and claiming priority to Korean Patent Application Nos. 10-2023-0015175, filed on Feb. 3, 2023, 10-2023-0032332, filed on Mar. 13, 2023, and 10-2023-0038931, filed on Mar. 24, 2023, in the Korean Intellectual Property Office, the disclosures of each of which are incorporated by reference herein in their entireties.

### BACKGROUND

### Field

The disclosure relates to a time division duplex (TDD) system. For example, the present disclosure relates to an electronic device including memory for an uplink and a downlink for the TDD system.

### Description of Related Art

As transmission capacity increases in wireless communication systems, a function split functionally separating base stations is being applied. According to the function split, base stations may be divided into a distributed unit (DU) and a radio unit (RU). A fronthaul interface is defined for communication between the DU and the RU.

The above-described information may be provided as a related art for the purpose of helping to understand the present disclosure. No assertion or determination is made as to whether any of the above-described information may be applied as a prior art related to the present disclosure.

### SUMMARY

According to an example embodiment, an electronic device may comprise: an antenna, analogue processing circuitry connected to the antenna, first digital processing circuitry configured for downlink (DL) signal processing, connected to the analogue processing circuitry, second digital processing circuitry configured for an uplink (UL) signal processing, connected to the analogue processing circuitry, at least one processor, comprising processing circuitry, individually and/or collectively, configured to cause memory to store DL samples of the first digital processing circuitry and UL samples of the second digital processing circuitry. The memory may be configured to store, in a designated time interval, first sample data for a first symbol, second sample data for a second symbol, and third sample data for a third symbol. The first sample data may comprise input data for a fast Fourier transform (FFT) for the first symbol. The second sample data may comprise output data for an inverse fast Fourier transform (IFFT) for the second symbol. The third sample data may comprise one of input data for the FFT for the third symbol and output data for the inverse fast Fourier transform (IFFT) for the third symbol. The first symbol, the second symbol, and the third symbol may be configured based on a time division duplex (TDD).

According to an example embodiment, an electronic device may comprise: an antenna, analogue processing circuitry connected to the antenna, first digital processing circuitry configured for a downlink (DL) signal processing, connected to the analogue processing circuitry, second digital processing circuitry configured for an uplink (UL) signal processing, connected to the analogue processing circuitry, memory configured to store DL samples of the first digital processing circuitry and UL samples of the second digital processing circuitry, and at least one processor comprising processing circuitry. At least one processor, individually and/or collectively, may be configured to cause the electronic device to: in a designated time interval, store first sample data for a first symbol to a first buffer included in the memory, store second sample data for a second symbol to a second buffer included in the memory, and output third sample data for a third symbol from a third buffer included in the memory. The first symbol, and the second symbol, and the third symbol may be configured based on a time division duplex (TDD). The first symbol may be followed by the second symbol. The second symbol may be followed by the third symbol.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example wireless communication system according to various embodiments;

FIG. 2A is a block diagram illustrating an example configuration of a fronthaul interface according to various embodiments;

FIG. 2B is a diagram illustrating an example fronthaul interface of an open (O)-radio access network (RAN) according to various embodiments;

FIG. 3A is a block diagram illustrating an example configuration of a distributed unit (DU) according to various embodiments;

FIG. 3B is a block diagram illustrating an example configuration of a radio unit (RU) according to various embodiments;

FIG. 4 is a diagram illustrating an example of a function split between a DU and an RU according to various embodiments;

FIG. 5A is a diagram illustrating an example of functional blocks for DL signal transmission according to various embodiments;

FIG. 5B is a diagram illustrating an example of a timing diagram for indicating an operation of DL memory according to various embodiments;

FIG. 6A is a diagram illustrating an example of an operation of DL memory in symbol #k according to various embodiments;

FIG. 6B is a diagram illustrating an example of an operation of DL memory in symbol #(k+1) according to various embodiments;

FIG. 7A is a diagram illustrating an example of functional blocks for UL signal transmission according to various embodiments;

FIG. 7B is a diagram illustrating an example of a timing diagram for indicating an operation of UL memory according to various embodiments;

FIG. 8A is a diagram illustrating an example of an operation of UL memory in symbol #k according to various embodiments;

FIG. 8B is a diagram illustrating an example of an operation of UL memory in symbol #(k+1) according to various embodiments;

FIG. 9 is a diagram illustrating an example operation of functional blocks in an FDD system according to various embodiments;

FIG. 10A is a diagram illustrating an example operation for DL of functional blocks in a TDD system according to various embodiments;

FIG. 10B is a diagram illustrating an example operation for UL of functional blocks in a TDD system according to various embodiments;

FIG. 11 is a diagram illustrating an example of functional blocks including TD memory according to various embodiments;

FIG. 12 is a diagram illustrating an example of a signal timing diagram of functional blocks for DL, in a time interval for a DL operation according to various embodiments;

FIG. 13 is a diagram illustrating an example of a signal timing diagram of functional blocks for UL, in a time interval for an UL operation according to various embodiments;

FIG. 14 is a diagram illustrating an example of a signal timing diagram, in a time interval for an UL operation and a time interval for a DL operation, according to various embodiments;

FIG. 15 is a diagram illustrating an example of a signal timing diagram of TD memory, according to DL traffic and UL traffic in an F-slot according to various embodiments;

FIG. 16 is a diagram illustrating an example of a signal timing diagram of TD memory, according to DL traffic and UL traffic in an F-slot according to various embodiments;

FIG. 17 is a diagram illustrating an example of a signal timing diagram of TD memory, according to DL traffic and UL traffic in an F-slot according to various embodiments;

FIG. 18 is a diagram illustrating an example of a signal timing diagram of TD memory, according to DL traffic and UL traffic in an F-slot according to various embodiments;

FIG. 19 is a diagram illustrating an example of circuits included in TD memory according to various embodiments;

FIG. 20 is a timing diagram illustrating signals used for an operation of TD memory according to various embodiments;

FIG. 21 is a diagram illustrating an example configuration of a write control circuit included in TD memory according to various embodiments.

FIG. 22 is a diagram illustrating an example configuration of a buffer selection control circuit included in a write control circuit according to various embodiments.

FIG. 23 is a diagram illustrating an example configuration of a buffer write control circuit included in a write control circuit according to various embodiments;

FIG. 24 is a timing diagram illustrating signals related to circuits included in a write control circuit according to various embodiments;

FIG. 25 is a diagram illustrating an example configuration of a read control circuit included in TD memory according to various embodiments;

FIG. 26 is a diagram illustrating an example configuration of a buffer read control circuit included in a read control circuit according to various embodiments.

FIG. 27 is a diagram illustrating an example configuration of a multiplexer circuit included in a read control circuit according to various embodiments;

FIGS. 28A and 28B are timing diagrams illustrating signals related to circuits included in a read control circuit according to various embodiments;

FIG. 29 is a diagram illustrating an example configuration of a buffer circuit included in TD memory according to various embodiments;

FIG. 30 is a diagram illustrating an example configuration of a buffer write circuit included in a buffer circuit according to various embodiments;

FIG. 31 is a diagram illustrating an example configuration of a buffer read circuit included in a buffer circuit according to various embodiments;

FIG. 32 is a diagram illustrating an example configuration of a buffer included in a buffer circuit according to various embodiments; and

FIG. 33 is a block diagram illustrating an example configuration of an electronic device according to various embodiments.

### DETAILED DESCRIPTION

Terms used in the present disclosure are used to describe various example embodiments, and are not intended to limit a range of the disclosure. A singular expression may include a plural expression unless the context clearly indicates otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

Terms referring to signal (e.g., signal, information, message, signaling), terms referring to resource (e.g., section, symbol, slot, subframe, radio frame, subcarrier, resource element (RE), resource block (RB), bandwidth part (BWP), occasion), terms referring to operation state (e.g., step, operation, procedure), terms referring to data (e.g., packet, message, user stream, information, bit, symbol, codeword), terms referring to channel, terms referring to network entity, and terms referring to components of a device, used in the following description are illustrated for convenience of explanation. Therefore, the present disclosure is not limited to terms used described below, and another term having an equivalent technical meaning may be used.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ may refer to including at least one of ‘C’ or ‘D’, that is, {′C′, ‘D’, and ‘C’ and ‘D’}.

Although the present disclosure describes various example embodiments using terms used in some communication standards (e.g., 3rd Generation Partnership Project (3GPP), extensible radio access network (xRAN), open-radio access network (O-RAN)), these are only examples for explanation. The various embodiments of the present disclosure may be easily modified and applied to other communication systems.

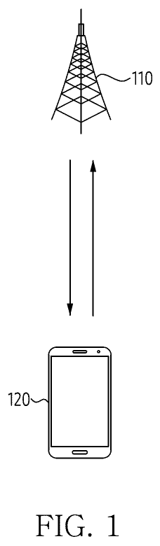

FIG. 1 is a diagram illustrating an example wireless communication system according to various embodiments.

Referring to FIG. 1, FIG. 1 illustrates a base station 110 and a terminal 120 as a portion of nodes that utilize a wireless channel in a wireless communication system. FIG. 1 illustrates only one base station, but a wireless communication system may further include another base station that is identical or similar to the base station 110.

The base station 110 is a network infrastructure that provides wireless access to the terminal 120. The base station 110 has coverage defined based on a distance at which a signal may be transmitted. In addition to ‘base station’, the base station 110 may be referred to as an ‘access point (AP)’, ‘eNodeB (eNB)’, ‘5th generation node’, ‘next generation nodeB (gNB)’, ‘wireless point’, ‘transmission/reception point (TRP)’ or other terms having equivalent technical meanings.

The terminal 120, which is a device used by a user, performs communication with the base station 110 through a wireless channel. A link from the base station 110 to the terminal 120 is referred to as a downlink (DL), and a link from the terminal 120 to the base station 110 is referred to as an uplink (UL). In addition, although not illustrated in FIG. 1, the terminal 120 and another terminal may perform communication with each other through a wireless channel. At this time, a link (device-to-device link (D2D)) between the terminal 120 and the other terminal is referred to as a sidelink, and the sidelink may be used interchangeably with a PC5 interface. In various embodiments, the terminal 120 may be operated without the user's involvement. According to an embodiment, the terminal 120, which is a device performing machine type communication (MTC), may not be carried by the user. Additionally, according to an embodiment, the terminal 120 may be a narrowband (NB)-internet of things (IoT) device.

In addition to ‘terminal’, the terminal 120 may also be referred to as ‘user equipment (UE)’, ‘customer premises equipment, (CPE)’, ‘mobile station’, ‘subscriber station’, ‘remote terminal’, ‘wireless terminal’, ‘electronic device’, ‘user device’, or other terms having equivalent technical meanings.

The base station 110 may perform beamforming with the terminal 120. The base station 110 and the terminal 120 may transmit and receive a wireless signal in a relatively low frequency band (e.g., frequency range 1 (FR 1) of NR). In addition, the base station 110 and the terminal 120 may transmit and receive a wireless signal in a relatively high frequency band (e.g., FR 2 (or FR 2-1, FR 2-2, FR 2-3) or FR 3), and a mmWave band (e.g., 28 GHz, 30 GHz, 38 GHz, 60 GHz). The base station 110 and the terminal 120 may perform beamforming to improve a channel gain. Herein, the beamforming may include transmission beamforming and reception beamforming. The base station 110 and the terminal 120 may provide directivity to a transmission signal or a reception signal. To this end, the base station 110 and the terminal 120 may select serving beams through a beam search or beam management procedure. After the serving beams are selected, subsequent communication may be performed through a resource in a QCL relationship with the resource transmitting the serving beams.

If large-scale characteristics of a channel carrying a symbol on a first antenna port may be inferred from a channel carrying a symbol on a second antenna port, the first antenna port and the second antenna port may be evaluated to be in the QCL relationship. For example, large-scale characteristics may include at least one of a delay spread, a Doppler spread, a Doppler shift, an average gain, an average delay, and a spatial receiver parameter.

Although FIG. 1 describes that both the base station 110 and the terminal 120 perform beamforming, various embodiments of the present disclosure are not necessarily limited thereto. In various embodiments, the terminal may or may not perform beamforming. In addition, the base station may or may not perform beamforming. That is, either only one of the base station and the terminal may perform beamforming, or neither the base station nor the terminal may perform beamforming.

In the present disclosure, a beam refers to a spatial flow of a signal in a wireless channel, and is formed by one or more antennas (or antenna elements), and this formation process may be referred to as beamforming. Beamforming may include at least one of analog beamforming or digital beamforming (e.g., precoding). A reference signal transmitted based on beamforming may include, for example, a demodulation-reference signal (DM-RS), a channel state information-reference signal (CSI-RS), a synchronization signal/physical broadcast channel (SS/PBCH), and a sounding reference signal (SRS). In addition, an IE such as CSI-RS resource or SRS-resource may be used as a configuration for each reference signal, and this configuration may include information related to the beam. The information related to the beam may refer to whether a corresponding configuration (e.g., CSI-RS resource) uses the same spatial domain filter as another configuration (e.g., another CSI-RS resource within the same CSI-RS resource set) or a different spatial domain filter, or which reference signal it is quasi-co-located (QCL) with, and if so, what type it is (e.g., QCL type A, B, C, D).

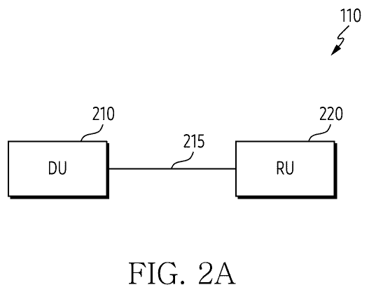

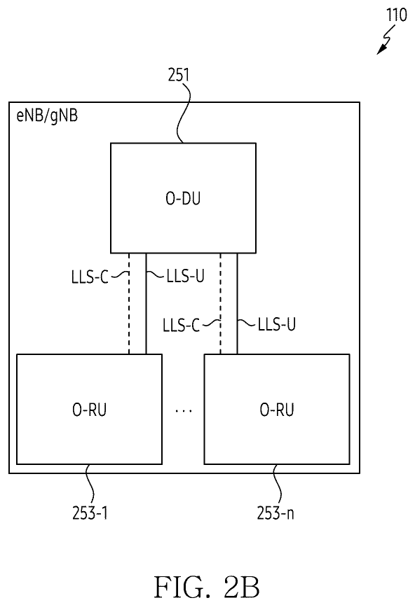

Conventionally, in a communication system with a relatively large cell radius of base station, each base station was installed to include a function of a digital processing unit (or distributed unit (DU)) and a radio frequency (RF) processing unit (or radio unit (RU)). However, as high frequency bands are used in 4th generation (4G) and/or subsequent communication systems (e.g., 5G) and the cell coverage of base stations becomes smaller, the number of base stations to cover a specific area has increased. The burden of installation cost for operators to install base stations has also increased. In order to minimize/reduce the installation cost of a base station, a structure in which the DU and RU of the base station are separated, one or more RUs are connected to one DU through a wired network, and one or more Rus geographically distributed to cover a specific area are deployed, has been proposed. Hereinafter, a deployment structure and expansion examples of a base station according to various embodiments of the present disclosure are described through FIGS. 2A and 2B.

FIG. 2A is a block diagram illustrating an example fronthaul interface according to various embodiments. The fronthaul refers to entities between a base station and a radio access network. FIG. 2A illustrates an example of a fronthaul structure between one DU 210 and one RU 220, but this is for convenience of explanation and the present disclosure is not limited thereto. In other words, the various example embodiments of the present disclosure may also be applied to a fronthaul structure between one DU and a plurality of RU. For example, various embodiments of the present disclosure may be applied to a fronthaul structure between one DU and two RU. In addition, various embodiments of the present disclosure may also be applied to a fronthaul structure between one DU and three RU.

Referring to FIG. 2A, the base station 110 may include a DU (e.g., including various circuitry) 210 and an RU (e.g., including various circuitry) 220. A fronthaul 215 between the DU 210 and the RU 220 may be operated via an Fx interface. For operation of the fronthaul 215, an interface such as an enhanced common public radio interface (eCPRI) or radio over ethernet (ROE) may be used.

As communication technology has been developed, mobile data traffic increased, and thus the bandwidth demand required in a fronthaul between a digital unit and a radio unit has increased significantly. In a deployment such as centralized/cloud radio access network (C-RAN), the DU may be implemented to perform functions for packet data convergence protocol (PDCP), radio link control (RLC), media access control (MAC), and physical (PHY), and the RU may be implemented to further perform functions for PHY layer in addition to a radio frequency (RF) function.

The DU 210 may be in charge of upper layer functions of a wireless network. For example, the DU 210 may perform functions of the MAC layer and a part of the PHY layer. Herein, a part of the PHY layer is a function performed at a higher level among the functions of the PHY layer, and may include, for example, channel encoding (or channel decoding), scrambling (or descrambling), modulation (or demodulation), and layer mapping (or layer demapping). According to an embodiment, if the DU 210 complies with an O-RAN standard, it may be referred to as an O-RAN DU (O-DU). The DU 210 may be replaced with and represented as a first network entity for a base station (e.g., gNB) in embodiments of the present disclosure, as needed.

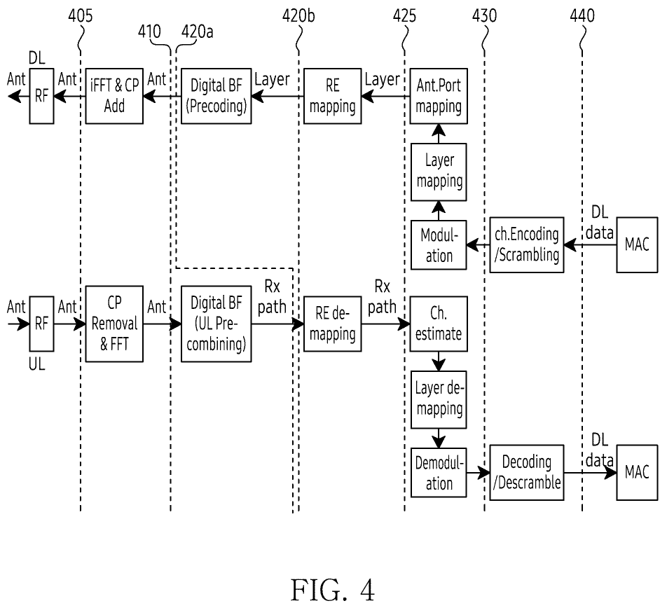

The RU 220 may be in charge of lower layer functions of a wireless network. For example, the RU 220 may perform a part of the PHY layer, and a RF function. Herein, a part of the PHY layer is a function performed at performed at a relatively lower level than the DU 210 among the functions of the PHY layer, and may include, for example, iFFT conversion (or FFT conversion), cyclic prefix (CP) insertion (or CP removal), and digital beamforming. In FIG. 4, an example of such a specific function split is described in detail. The RU 220 may be referred to as access unit (AU), access point (AP), transmission/reception point (TRP), remote radio head (RRH), radio unit (RU), or other terms having equivalent technical meanings. According to an embodiment, if the RU 220 complies with the O-RAN standard, it may be referred to as an O-RAN RU (O-RU). The RU 220 may be replaced with and represented as a second network entity for a base station (e.g., gNB) in embodiments of the present disclosure, as needed.

Although FIG. 2A describes that the base station 110 includes the DU 210 and the RU 220, various example embodiments of the present disclosure are not limited thereto. The base station according to various embodiments may be implemented in a distributed deployment according to a centralized unit (CU) configured to perform functions of upper layers (e.g., packet data convergence protocol (PDCP), radio resource control (RRC)) of an access network and a distributed unit (DU) configured to perform functions of lower layers. At this time, the distributed unit (DU) may include the digital unit (DU) and the radio unit (RU) of FIG. 1. Between a core (e.g., 5G core (5GC) or next generation core (NGC)) network and a radio access network (RAN), the base station may be implemented in a structure in which CU, DU, and RU are arranged in order. An interface between the CU and the distributed unit (DU) may be referred to as an FI interface.

A centralized unit (CU) may be in charge of functions of a higher layer than the DU, by being connected to one or more DUs. For example, the CU may be in charge of radio resource control (RRC) and a function of a packet data convergence protocol (PDCP) layer, and the DU and the RU may be in charge of functions of lower layers. The DU may perform radio link control (RLC), media access control (MAC), and some functions (high PHY) of PHY layer, and the RU may perform remaining functions (low PHY) of the PHY layer. In addition, as an example, a digital unit (DU) may be included in a distributed unit (DU) according to the implementation of distributed deployment of the base station. Hereinafter, unless otherwise defined, it is described as operations of the digital unit (DU) and the RU, but various embodiments of the present disclosure may be applied to both of a base station arrangement including the CU or an arrangement where the DU is directly connected to a core network (e.g., the CU and the DU are integrated into a base station (e.g., NG-RAN node) which is a single entity).

FIG. 2B is a diagram illustrating an example fronthaul interface of an open (O)-radio access network (RAN) according to various embodiments. As a base station 110 according to distributed deployment, cNB or gNB is illustrated.

Referring to FIG. 2B, the base station 110 may include an O-DU 251 and O-RUs 253-1, . . . , and 253-n. Hereinafter, for convenience of explanation, an operation and a function of the O-RU 253-1 may be understood as a description of each of other O-RUs (e.g., O-RU 253-n).

The O-DU 251 is a logical node including functions among functions of a base station (e.g., cNB, gNB) according to FIG. 4 to be described later, except for functions allocated exclusively to the O-RU 253-1. The O-DU 251 may control operations of the O-RUs 253-1, . . . , and 253-n. The O-DU 251 may be referred to as a lower layer split (LLS) central unit (CU). The O-RU 253-1 is a logical node including a subset among the functions of a base station (e.g., eNB, gNB) according to FIG. 4 to be described later. The real-time aspect of the control plane (C-plane) communication and user plane (U-plane) communication with the O-RU 253-1 may be controlled by the O-DU 251.

The O-DU 251 may perform communication with the O-RU 253-1 through an LLS interface. The LLS interface corresponds to a fronthaul interface. The LLS interface refers to a logical interface between the O-DU 251 and the O-RU 253-1 using lower layer function split (e.g., intra-PHY-based function split). The LLS-C between the O-DU 251 and the O-RU 253-1 provides a C-plane through the LLS interface. The LLS-U between the O-DU 251 and the O-RU 253-1 provides a U-plane through the LLS interface.

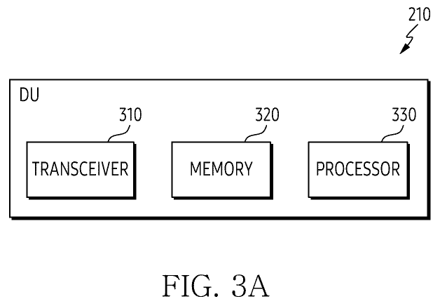

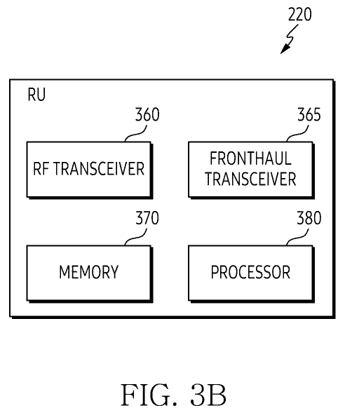

In FIG. 2B, entities of the base station 110 have been described as O-DU and O-RU to describe O-RAN. However, these designations are not to be construed as limiting the various example embodiments of the present disclosure. In various embodiments described with reference to FIGS. 3A to 15, operations of the DU 210 may also be performed by the O-DU 251. A description of the DU 210 may be applied to the O-DU 251. According to various example embodiments described with reference to FIGS. 3A to 15, operations of the RU 220 may also be performed by the O-RU 253-1. A description of the RU 220 may be applied to the O-RU 253-1.

FIG. 3A is a block diagram illustrating an example configuration of a distributed unit (DU) according to various embodiments. A configuration illustrated in FIG. 3A, which is as a part of a base station, may be understood as a configuration of the DU 210 of FIG. 2A (or the O-DU 251 of FIG. 2B). Hereinafter, the terms ‘ . . . unit’ and ‘ . . . er’ used below refer to a unit processing at least one function or operation, which may be implemented by hardware or software, or a combination of hardware and software.

Referring to FIG. 3A, a DU 210 includes a transceiver 310, memory 320, and a processor (e.g., including processing circuitry) 330.

The transceiver 310 may perform functions for transmitting and receiving a signal in a wired communication environment. The transceiver 310 may include a wired interface for controlling a direct device-to-device connection through a transmission medium (e.g., copper wire, optical fiber). For example, the transceiver 310 may transmit an electrical signal to another device through a copper wire or perform conversion between an electrical signal and an optical signal. The DU 210 may communicate with a radio unit (RU) through the transceiver 310. The DU 210 may be connected to a core network or a CU of a distributed deployment through the transceiver 310.

The transceiver 310 may also perform functions for transmitting and receiving a signal in a wireless communication environment. For example, the transceiver 310 may perform a conversion function between a baseband signal and a bit string according to a physical layer specification of a system. For example, upon transmitting data, the transceiver 310 generates complex-valued symbols by encoding and modulating a transmission bit string. In addition, upon receiving data, the transceiver 310 restores a received bit string by demodulating and decoding a baseband signal. In addition, the transceiver 310 may include a plurality of transmission/reception paths. In addition, according to an embodiment, the transceiver 310 may be connected to a core network or to other nodes (e.g., integrated access backhaul (IAB)).

The transceiver 310 may transmit and receive a signal. For example, the transceiver 310 may transmit a management plane (M-plane) message. For example, the transceiver 310 may transmit a synchronization plane (S-plane) message. For example, the transceiver 310 may transmit a control plane (C-plane) message. For example, the transceiver 310 may transmit a user plane (U-plane) message. For example, the transceiver 310 may receive the U-plane message. Although only the transceiver 310 is illustrated in FIG. 3A, the DU 210 may include two or more transceivers according to another implementation.

The transceiver 310 transmits and receives a signal as described above. Accordingly, all or some of the transceiver 310 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the transceiver 310.

Although not illustrated in FIG. 3A, the transceiver 310 may further include a backhaul transceiver for connection with a core network or another base station. The backhaul transceiver provides an interface for performing communication with other nodes in the network. In other words, the backhaul transceiver converts a bit string transmitted from a base station to another node, such as another access node, another base station, an upper node, and a core network into a physical signal, and converts a physical signal received from another node into a bit string.

The memory 320 stores a basic program, an application program, and data such as configuration information for an operation of the DU 210. The memory 320 may be referred to as a storage unit. The memory 320 may be configured with a volatile memory, a nonvolatile memory, or a combination of the volatile memory and the nonvolatile memory. In addition, the memory 320 provides stored data according to a request from the processor 330.

The processor 330 may include various processing circuitry and controls overall operations of the DU 210. The processor 380 may be referred to as a control unit. For example, the processor 330 transmits and receives a signal through the transceiver 310 (or through a backhaul communication unit). In addition, the processor 330 writes and reads data in the memory 320. In addition, the processor 330 may perform functions of a protocol stack required in a communication standard. Although only the processor 330 is illustrated in FIG. 3A, the DU 210 may include two or more processors according to another implementation. Thus, the processor 330 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

A configuration of the DU 210 illustrated in FIG. 3A is an example, and an example of the DU performing the various embodiments of the present disclosure is not limited to the configuration illustrated in FIG. 3A. In various embodiments, some configurations may be added, deleted, or changed.

FIG. 3B is a diagram illustrating an example configuration of a radio unit (RU) according to various embodiments. A configuration illustrated in FIG. 3B, which is as a part of a base station, may be understood as a configuration of the RU 220 of FIG. 2A or the O-RU 253-1 of FIG. 2B. Hereinafter, the terms ‘ . . . unit’ and ‘ . . . er’ used below refer to a unit processing at least one function or operation, which may be implemented by hardware or software, or a combination of hardware and software.

Referring to FIG. 3B, the RU 220 includes an RF transceiver 360, a fronthaul transceiver 365, memory 370, and a processor (e.g., including processing circuitry) 380.

The RF transceiver 360 performs functions for transmitting and receiving a signal through a wireless channel. For example, the RF transceiver 360 up-converts a baseband signal into an RF band signal and then transmits it through an antenna, and down-converts an RF band signal received through the antenna into a baseband signal. For example, the RF transceiver 360 may include a transmission filter, a reception filter, an amplifier, a mixer, an oscillator, a DAC, an ADC.

The RF transceiver 360 may include a plurality of transmission/reception paths. Furthermore, the RF transceiver 360 may include an antenna unit. The RF transceiver 360 may include at least one antenna array including a plurality of antenna elements. In terms of hardware, the RF transceiver 360 may be including a digital circuit and an analog circuit (e.g., a radio frequency integrated circuit (RFIC)). Herein, the digital circuit and the analog circuit may be implemented as a single package. In addition, the RF transceiver 360 may include a plurality of RF chains. The RF transceiver 360 may perform beamforming. In order to provide directivity to a signal to be transmitted and received according to the setting of the processor 380, the RF transceiver 360 may apply beamforming weights to the signal. According to an embodiment, the RF transceiver 360 may include a radio frequency (RF) block (or RF unit).

According to an embodiment, the RF transceiver 360 may transmit and receive a signal on a radio access network. For example, the RF transceiver 360 may transmit a downlink signal. The downlink signal may include a synchronization signal (SS), a reference signal (RS) (e.g., cell-specific reference signal (CRS), demodulation (DM)-RS), system information (e.g., MIB, SIB, remaining system information (RMSI), other system information (OSI)), configuration message, control information or downlink data. In addition, for example, the RF transceiver 360 may receive an uplink signal. The uplink signal may include a random access-related signal (e.g., random access preamble (RAP)) (or message 1 (Msg1), message 3 (Msg3)), a reference signal (e.g., sounding reference signal (SRS), DM-RS), or a power headroom report (PHR). Although only the RF transceiver 360 is illustrated in FIG. 3B, the RU 220 may include two or more RF transceivers according to another implementation.

According to various embodiments, the RF transceiver 460 may transmit an RIM-RS. The RF transceiver 460 may transmit a first type of RIM-RS (e.g., RIM-RS type 1 of 3GPP) to notify the detection of remote interference. The RF transceiver 460 may transmit a second type of RIM-RS (e.g., RIM-RS type 2 of 3GPP) for notifying the presence or absence of remote interference.

The fronthaul transceiver 365 may transmit and receive a signal. According to an embodiment, the fronthaul transceiver 365 may transmit and receive a signal on a fronthaul interface. For example, the fronthaul transceiver 365 may receive a management plane (M-plane) message. For example, the fronthaul transceiver 365 may receive a synchronization plane (S-plane) message. For example, the fronthaul transceiver 365 may receive a control plane (C-plane) message. For example, the fronthaul transceiver 365 may transmit a user plane (U-plane) message. For example, the fronthaul transceiver 365 may receive a U-plane message. Although only the fronthaul transceiver 365 is illustrated in FIG. 3B, the RU 220 may include two or more fronthaul transceivers according to another implementation.

As described above, the RF transceiver 360 and the fronthaul transceiver 365 transmit and receive a signal. Accordingly, all or some of the RF transceiver 360 and the fronthaul transceiver 365 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the RF transceiver 360. In the following description, transmission and reception performed through a wireless channel are used to the meaning including that the processing as described above is performed by the RF transceiver 360.

The memory 370 stores a basic program, an application program, and data such as configuration information for an operation of the RU 220. The memory 370 may be referred to as a storage unit. The memory 370 may be configured with a volatile memory, a nonvolatile memory, or a combination of the volatile memory and the nonvolatile memory. In addition, the memory 370 provides stored data according to a request from the processor 380. According to an embodiment, the memory 370 may include a memory for a condition, a command, or a setting value related to an SRS transmission scheme.

The processor 380 may include various processing circuitry and controls overall operations of the RU 320. The processor 380 may be referred to as a control unit. For example, the processor 380 transmits and receives a signal through the RF transceiver 360 or the fronthaul transceiver 365. In addition, the processor 380 writes and reads data in the memory 370. In addition, the processor 380 may perform functions of a protocol stack required by a communication standard. Although only the processor 380 is illustrated in FIG. 3B, the RU 220 may include two or more processors according to another implementation. The processor 380, which is an instruction set or code stored in the memory 370, may be an instruction/code at least temporarily resided in the processor 380 or a storage space storing instruction/code, or part of circuitry of the processor 380. In addition, the processor 380 may include various modules for performing communication. Thus, the processor 380 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 380 may control the RU 220 to perform operations according to various embodiments to be described in greater detail below.

A configuration of the RU 220 illustrated in FIG. 3B is an example, and an example of the RU performing various embodiments of the present disclosure is not limited to the configuration illustrated in FIG. 3B. In various embodiments, some configurations may be added, deleted, or changed.

FIG. 4 is a diagram illustrating an example of a function split between a DU and an RU according to various embodiments. As wireless communication technology advances (e.g., the introduction of 5th generation (5G) communication system (or new radio (NR) communication system)), the used frequency bands have increased further. As a cell radius of base stations became very small, the number of RUs required to be installed further increased. In addition, in the 5G communication system, as the amount of data transmitted has increased significantly by more than 10 times, a transmission capacity of a wired network transmitted to a fronthaul has increased significantly. Due to the above-described factors, the installation cost of a wired network in the 5G communication system may be increased significantly. Therefore, in order to reduce the transmission capacity of the wired network and reduce the installation cost of the wired network, a ‘function split’ to reduce the transmission capacity of the fronthaul by transferring some functions of the DU's modem to the RU may be used.

In order to reduce the burden on the DU, a role of the RU, which was in charge of only the existing RF function, may be extended to include some functions of a physical layer. As the RU performs functions of the higher layer, the throughput of the RU increases, which may increase a transmission bandwidth in the fronthaul while lowering the delay time requirement constraints due to response processing. On the other hand, as the RU performs the functions of the higher layer, a virtualization gain decreases and the size, weight, and cost of the RU increase. In consideration of the trade-off of the above-described advantages and disadvantages, it is required to implement an optimal function split.

Referring to FIG. 4, function splits in a physical layer below a MAC layer are illustrated. In a case of downlink (DL) transmitting signals to a terminal through a wireless network, a base station may sequentially perform channel encoding/scrambling, modulation, layer mapping, antenna mapping, RE mapping, digital beamforming (e.g., precoding), iFFT conversion/CP insertion, and RF conversion. In a case of uplink (UL) receiving signals from a terminal through the wireless network, the base station may sequentially perform RF conversion, FFT conversion/CP removal, digital beamforming (pre-combining), RE demapping, channel estimation, layer demapping, demodulation, decoding/discrambling. According to the above-described trade-off, the split of uplink functions and downlink functions may be defined in various types, by needs among vendors, discussion of standards, and the like.

In a first function split 405, a first function split in which the RU performs the RF function, and the DU performs the PHY function is substantially such that the PHY function is not implemented within the RU, and, for example, may be referred to as Option 8. In a second function split 410, the RU performs iFFT conversion/CP insertion in the DL of the PHY function and FFT conversion/CP removal in the UL, and the DU performs the remaining PHY functions. As an example, the second function split 410 may be referred to as Option 7-1. In a third function split 420a, the RU performs iFFT conversion/CP insertion in the DL of the PHY function and FFT conversion/CP removal and digital beamforming in the UL, and the DU performs the remaining PHY functions. As an example, the third function split 420a may be referred to as Option 7-2x Category A. In a fourth function split 420b, the RU performs digital beamforming in both DL and UL, and the DU performs upper PHY functions after digital beamforming. As an example, the fourth function split 420b may be referred to as Option 7-2x Category B. In a fifth function split 425, the RU performs RE mapping (or RE demapping) in both DL and UL, and the DU performs upper PHY functions after RE mapping (or RE demapping). As an example, the fifth function split 425 may be referred to as Option 7-2. In a sixth function split 430, the RU performs up to modulation (or demodulation) in both DL and UL, and the DU performs upper PHY functions after modulation (or demodulation). As an example, the sixth function split 430 may be referred to as Option 7-3. In a seventh function split 440, the RU performs up to encoding/scrambling (or decoding/discrambling) in both DL and UL, and the DU performs upper PHY functions after modulation (or demodulation). As an example, the seventh function split 440 may be referred to as option 6.

According to an embodiment, in a case that a large amount of signal processing is expected, such as in FR 1 MMU, a function split (e.g., the fourth function split 420b) in a relatively high layer may be required to reduce a fronthaul capacity. Additionally, in a function split (e.g., the sixth function split 430) at a too high layer, as a control interface becomes complex and multiple PHY processing blocks are included in the RU, which may cause a burden on the implementation of the RU, a suitable function split may be required according to the arrangement and implementation method of the DU and RU.

According to an embodiment, in a case that precoding of data received from the DU cannot be processed (e.g., in a case that there is a limit to the precoding capability of the RU), the third function split 420a or a lower function split (e.g., the second function split 410) may be applied. Conversely, in a case that there is a capability to process precoding of data received from the DU, the fourth function split 420b or a higher function split (e.g., the sixth function split 430) may be applied.

Hereinafter, in the present disclosure, unless otherwise specified, the various embodiments are described based on a third function split 420a (which may be referred to as category A (CAT-A)) or a fourth function split 420b (which may be referred to as category B (CAT-B)) for performing beamforming processing at the RU. The O-RAN standard distinguishes the type of O-RU according to whether a precoding function is located at the interface of the O-DU or the O-RU interface. An O-RU in which precoding is not performed (e.g., low complexity) may be referred to as a CAT-A O-RU. An O-RU in which precoding is performed may be referred to as a CAT-B O-RU.

Hereinafter, the upper PHY refers to a physical layer processing processed in a DU of a fronthaul interface. For example, the upper PHY may include FEC encoding/decoding, scrambling, modulation/demodulation. Hereinafter, the lower PHY refers to a physical layer processing processed by an RU of a fronthaul interface. For example, the lower PHY may include FFT/iFFT, digital beamforming, and physical random access channel (PRACH) extraction and filtering. However, the above-described criterion does not exclude embodiments through other function splits. A function configuration, signaling, or operation of embodiments described below may be applied not only to the third function split 420a or the fourth function split 420b but also to other function split.

The various embodiments of the present disclosure describe standards of eCPRI and O-RAN as a fronthaul interface when transmitting a message between a DU (e.g., the DU 210) of FIG. 2A) and an RU (e.g., the RU 220 of FIG. 2A). The Ethernet payload of the message may include an eCPRI header, an O-RAN header, and an additional field. Hereinafter, various embodiments of the present disclosure are described using standard terms of eCPRI or O-RAN, but other expressions having equivalent meanings to each term may be used as substitutes in various embodiments of the present disclosure. Hereinafter, various embodiments of the present disclosure are described using standard terms of eCPRI or O-RAN, but are not limited thereto. For example, in various embodiments of the present disclosure, CPRI standard may be used as the fronthaul interface.

Ethernet and eCPRI, which are easy to share with networks, may be used as a transport protocol of fronthaul. The eCPRI header and the O-RAN header may be included in the Ethernet payload. The eCPRI header may be located at the front of the Ethernet payload. The eCPRI header may include the following contents.
1) ccpriVersion (4 bits): This parameter indicates an eCPRI protocol version.
2) ccpriReserved (3 bits): This parameter is reserved for further use of eCPRI.
3) ccpriConcatenation (1 bit): This parameter indicates when eCPRI concatenation is in use.
4) ecpriMessage (1 byte): This parameter indicates a type of a service carried by a message type. For example, the parameter indicates an IQ data message, a real-time control data message, or a transport network delay measurement message.
5) ccpriPayload (2 bytes): This parameter indicates a byte size of a payload portion of the eCPRI message.
6) ecpriRtcid/ecpriPcid (2 bytes): This parameter is an extended Antenna-carrier (eAxC) identifier (cAxC ID) and identifies a specific data flow related to each of C-plane (ecpriRtcid) or U-plane (ccpriPcid) message.
7) ccpriSeqid (2 bytes): This parameter provides unique message identification and order at two levels. The first octet of this parameter is a sequence ID used to identify the order of messages within an eAxC message stream, and the sequence ID is used to ensure that all messages are received and to reorder out-of-order messages. The second octet of this parameter is a subsequence ID. The subsequence ID is used to verify ordering and implement reordering when radio-transport-level (eCPRI or IEEE-1914.3) fragmentation occurs.

The eAxC identifier (ID) includes a band and sector identifier ‘BandSector_ID’, a component carrier identifier ‘CC_ID’, a spatial stream identifier ‘RU_Port_ID’, and a distributed unit identifier ‘DU_Port_ID’. The bit allocation of the eAxC ID may be distinguished as follows.
1) DU_port ID: The DU_port ID is used to distinguish processing units in the O-DU (e.g. different baseband cards). It is expected that the O-DU will allocate bits for the DU_port ID and the O-RU will attach the same value to the UL U-plane message carrying the same sectionId data.
2) BandSector_ID: Aggregated cell identifier (identification of band and sector supported by O-RU).
3) CC_ID: CC_ID identifies carrier components supported by the O-RU.
4) RU_port ID: The RU_port ID designates logical flows such as data layer or spatial streams, and logical flows such as separate numerologies (e.g., PRACH) or signal channels like SRS requiring specific antenna assignments.

An application protocol of the fronthaul may include a control plane (C-plane), a user plane (U-plane), a synchronization plane (S-plane), and a management plane (M-plane).

The control plane may be configured to provide scheduling information and beamforming information via a control message. The control plane may refer to real-time control between the DU and the RU. The user plane may include IQ sample data transmitted between the DU and the RU. The user plane may include downlink data (IQ data or SSB/RS), uplink data (IQ data or SRS/RS), or PRACH data of the user. A weight vector of the beamforming information described above may be multiplied by the user's data. The synchronization plane generally refers to traffic between the DU and the RU for a synchronization controller (e.g., IEEE grand master). The synchronization plane may be related to timing and synchronization. The management plane may refer to non-real-time control between the DU and the RU. The management plane may be related to initial setup, non-realtime reset or reset, and non-realtime report.

A message in the control plane, that is, the C-plane message, may be encapsulated based on a two-layer header approach. A first layer may be configured with eCPRI common header or the IEEE 1914.3 common header, which includes fields used to indicate a message type. A second layer is an application layer, which includes fields necessary for control and synchronization. In the application layer, a section defines a characteristic of U-plane data transmitted or received on a beam with one pattern ID. The section types supported within the C-plane are as follows.

Section Type may indicate the purpose of the control message transmitted in the control plane. For example, the purposes by Section Type are as follows.
1) section Type=0: Used to indicate resource blocks or symbols not used in the DL or the UL.
2) sectionType=1: Used for most DL/UL wireless channels. Herein, “most” refers to channels that do not require time or frequency offsets such as those required for mixed numerology channels.
3) sectionType=2: reserved for further use
4) sectionType=3: PRACH and mixed-numerology channels. Channels that require time or frequency offsets or differ from the nominal SCS value(s).
5) section Type=4: reserved for further use
6) sectionType=5: UE scheduling information. Transmits UE scheduling information so that the RU can perform real-time BF weight calculation (O-RAN optional BF method)
7) sectionType=6: Transmit UE-specific channel information. Periodically transmits UE channel information so that the RU can perform real-time BF weight calculation (O-RAN optional BF method)
8) sectionType=7: Used for licensed assisted access (LAA) support

In the following description, a technical feature for reducing memory for converting a time-frequency domain for baseband downlink (DL) (hereinafter referred to as DL) and/or baseband uplink (UL) (hereinafter referred to as UL) traffic signals in a wireless communication system using a time division duplex (TDD) method may be described. The memory may be used to convert a digital signal of a frequency domain into a digital signal of a time domain in units of orthogonal frequency division multiplexing (OFDM) symbols in DL. The memory may be used in UL to convert a digital signal of a time domain into a digital signal of a frequency domain in units of OFDM symbols. In the following disclosure, a technical feature for reducing memory resources and power consumption required for frequency-time domain conversion using a DL-UL time division characteristic, which is a characteristic of TDD system, may be proposed.

According to an embodiment, a massive multi-input multi-output unit (MMU) and/or a radio unit (RU) of a wireless communication system may process a signal between a modem and a terminal. For example, in DL, a digital signal of a frequency domain based on OFDM received from the modem may be converted into a digital signal of a time domain, based on an inverse fast-Fourier transform (IFFT) in units of N-point symbols. The digital signal in the time domain may be converted into an analog radio signal, based on a designated processing process. The analog radio signal may be radiated through an antenna. The terminal may receive the analog radio signal radiated through the antenna.

For example, when an operating clock frequency is integer times higher than a sampling-rate of a signal, signals of a plurality of antenna paths may be processed in one IFFT block within the same time interval. DL memory may be included in an electronic device (e.g., the RU 220 of FIG. 2A) to output IFFT output signals sequentially processed in units of OFDM symbols at the same time as a global positioning system (GPS) synchronization signal (e.g., 1 pulse per second (PPS)). When a DL signal is radiated and transmitted to a terminal, DL memory disposed at an output end of the IFFT block may be included in an electronic device (e.g., the RU 220 of FIG. 2A) to insert a cyclic-prefix (CP) for preventing/reducing interference between each symbol.

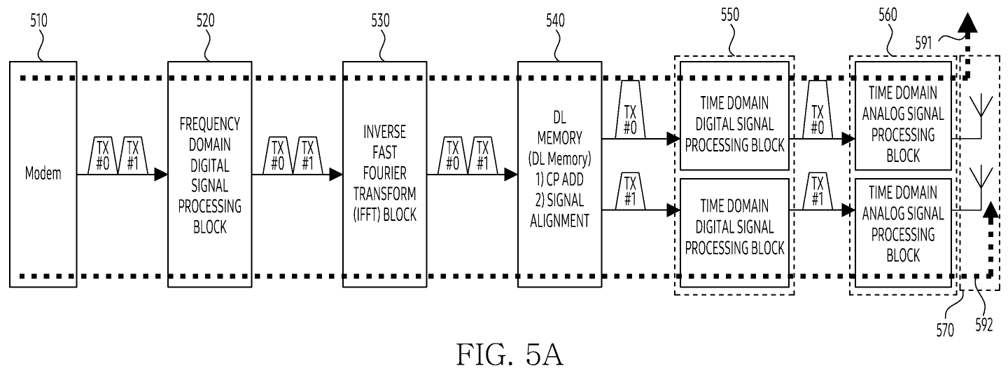

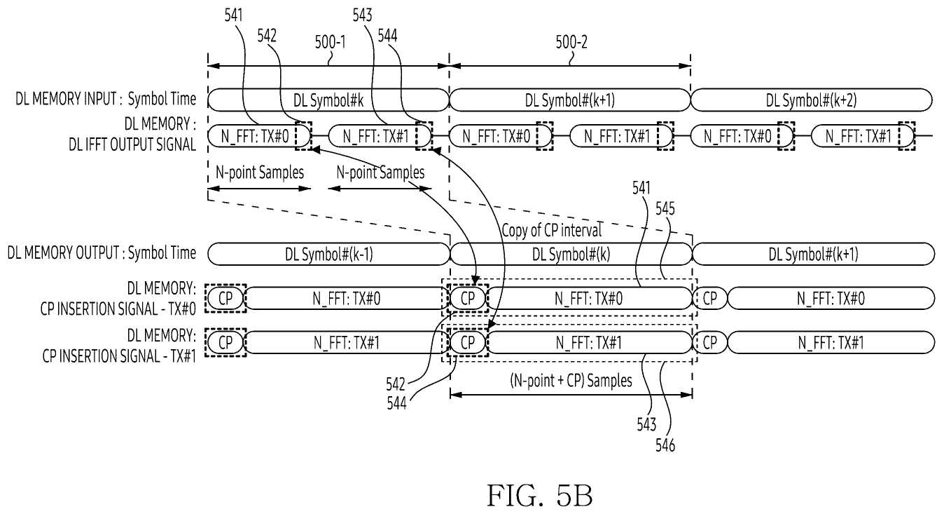

FIG. 5A is a diagram illustrating an example of functional blocks for DL signal transmission according to various embodiments.

FIG. 5B is a timing diagram illustrating an example operation of DL memory according to various embodiments.

Referring to FIG. 5A, a modem 510, a frequency domain digital signal processing block 520, an inverse fast Fourier transform block 530, DL memory 540, a time domain digital signal processing block 550, a time domain analog signal processing block 560, and an antenna circuit 570 may be used for DL signal transmission. At least a portion of the modem 510, the frequency domain digital signal processing block 520, the inverse fast Fourier transform block 530, the DL memory 540, the time domain digital signal processing block 550, the time domain analog signal processing block 560, and the antenna circuit 570 may be included in the DU 210. A remaining portion of the modem 510, the frequency domain digital signal processing block 520, the inverse fast Fourier transform block 530, the DL memory 540, the time domain digital signal processing block 550, the time domain analog signal processing block 560, and the antenna circuit 570 may be included in the RU 220.

Hereinafter, for convenience of description, it will be described that the modem 510 is included in the DU 210, the frequency domain digital signal processing block 520, the inverse fast Fourier transform block 530, the DL memory 540, the time domain digital signal processing block 550, the time domain analog signal processing block 560, and the antenna circuit 570 are included in the RU 220. The DU 210 (or the processor 330 of the DU 210) may control the modem 510. The RU 220 (or the processor 380 of the RU 220) may control at least one of the frequency domain digital signal processing block 520, the inverse fast Fourier transform block 530, the DL memory 540, the time domain digital signal processing block 550, the time domain analog signal processing block 560, and the antenna circuit 570.

When an operating clock frequency is twice as high as a DL sampling rate, an electrical path 591 and an electrical path 592 may be configured for a DL signal. For example, the DL memory 540 may have a 2-path multiplexer (MUX) structure. Hereinafter, a timing diagram for indicating an operation of the DL memory 540 will be described with reference to FIG. 5B.

Referring to FIG. 5B, in the DL memory 540, a time interval 500-1 for inputting DL symbol #k may be set. A DL IFFT output signal 541 and a DL IFFT output signal 543 may be output from the inverse fast Fourier transform block 530 within the time interval 500-1. The DL IFFT output signal 541 and the DL IFFT output signal 543 may be stored in the DL memory 540 within the time interval 500-1.

In the DL memory 540, a time interval 500-2 for output of the DL symbol #k may be set. The time interval 500-2 for output of the DL symbol #k may correspond to a time interval for input of a DL symbol #(k+1). A CP inserted signal 545 and a CP inserted signal 546 may be output from the DL memory 540 within the time interval 500-2. The CP inserted signal 545 may include the IFFT output signal 541 and a signal 542 that is a portion of the IFFT output signal 541 set to the CP. The CP inserted signal 546 may include the IFFT output signal 543 and a signal 544 that is a portion of the IFFT output signal 543 set to the CP.

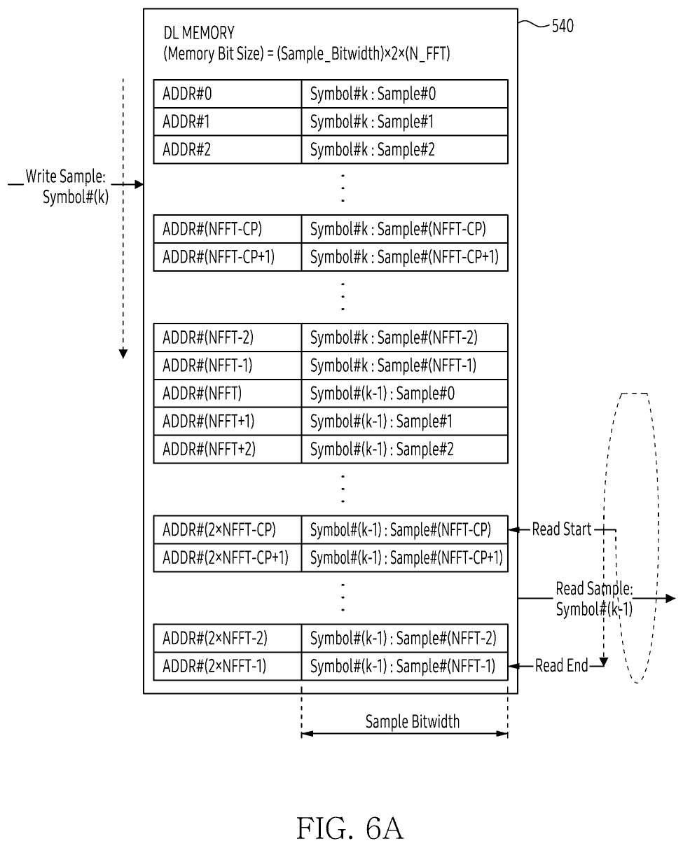

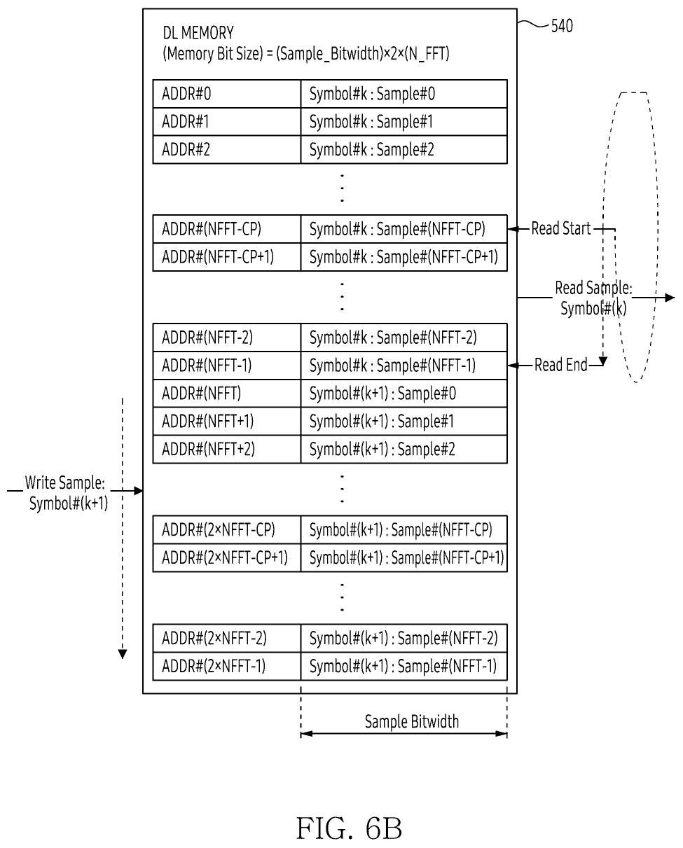

An operation of the DL memory 540 according to the above-described operation will be described in greater detail below with reference to FIGS. 6A and 6B.

FIG. 6A is a diagram illustrating an example operation of DL memory in symbol #k according to various embodiments.

FIG. 6B is a diagram illustrating an example operation of DL memory in symbol #(k+1) according to various embodiments.

Referring to FIG. 6A, in a time interval (e.g., the time interval 500-1 of FIG. 5B) set for the input of DL symbol #k in the DL memory 540, the output of the inverse fast Fourier transform block 530 may be configured with time domain samples as large as a size of N-FFT. For CP insertion, IFFT samples may be stored in the DL memory 540 until all N IFFT samples are written (or stored).

In a time interval (e.g., the time interval 500-1 of FIG. 5B) set for the input of DL symbol #k in the DL memory 540, while the output of the inverse fast Fourier transform block 530 is written (or stored) in the DL memory 540, samples written (or stored) at a time interval set for the input of DL symbol #(k−1) in the DL memory 540 may be read so that a CP is inserted and output.

For example, the RU 220 (or the processor 380 of the RU 220) may write a signal output from the inverse fast Fourier transform block 530 from address #0 (ADDR #0) to address #(NFFT−1) (ADDR #(NFFT−1)) of the DL memory 540.

For example, for CP insertion, the RU 220 may read data stored from address #(2×NFFT−CP) (ADDR #(2×NFFT−CP)) to address #(2×NFFT−1) (ADDR #(2×NFFT−1)) of the DL memory 540. Thereafter, the RU 220 may read data stored from address #(NFFT) (ADDR #(NFFT)) to address #(2×NFFT−1) (ADDR #(2×NFFT−1)) of the DL memory 540.

Referring to FIG. 6B, when the output of the inverse fast Fourier transform block 530 corresponding to the DL symbol #(k+1) is written in the DL memory 540, samples written (or stored) at a time point corresponding to the DL symbol #k may be read so that a CP is inserted and output.

For example, the RU 220 (or the processor 380 of the RU 220) may write a signal output from the inverse fast Fourier transform block 530 from address #(NFFT) (ADDR #(NFFT)) to address #(2×NFFT−1) (ADDR #(2×NFFT−1)) of the DL memory 540.

For example, for CP insertion, the RU 220 may read data stored from address #(NFFT−CP) (ADDR #(NFFT−CP)) to address #(NFFT−1) (ADDR #(NFFT−1)) of the DL memory 540. Thereafter, the RU 220 may read data stored from address #0 (ADDR #0) to address #(NFFT−1) (ADDR #(NFFT−1)) of the DL memory 540.

Referring to FIGS. 6A and 6B, the DL memory 540 may operate based on a time delay of a length of one symbol. Therefore, a bit-size of the DL memory 540 according to one antenna path may be set as shown in the following equation.

$$( D / L Memory Bit Size ) = ( Sample Bitwidth ) \times 2 \times ( N\_FFT ) \qquad [ Equation 1 ]$$

Referring to Equation 1, ‘DL Memory Bit Size’ may refer to a bit-size of the DL memory 540. ‘Sample Bitwidth’ may refer, for example, to a bit width of one FFT sample (or IFFT sample). ‘N_FFT’ may refer to a size of FFT.

According to an embodiment, in UL, in symmetry with DL, a signal received from a terminal may be converted into a digital signal of a time domain based on a designated processing process. The digital signal of the time domain may be converted into a digital signal in a frequency domain, based on fast-Fourier transform (FFT) in units of N-point symbol. The digital signal of the frequency domain may be transferred (or transmitted) to a modem.

For example, when an operating clock frequency is integer times higher than a sampling-rate of a signal, signals of a plurality of antenna paths may be processed in one FFT block within the same time interval. UL memory for sequentially transferring (or transmitting) a digital signal in a time domain, which is aligned based on an offset (e.g., UL advanced time) set based on a global positioning system (GPS) synchronization signal (e.g., 1 pulse per second (PPS)) and is input at the same time point, to the FFT block in units of N-point symbols may be included in an electronic device (e.g., the RU 220 of FIG. 2A).

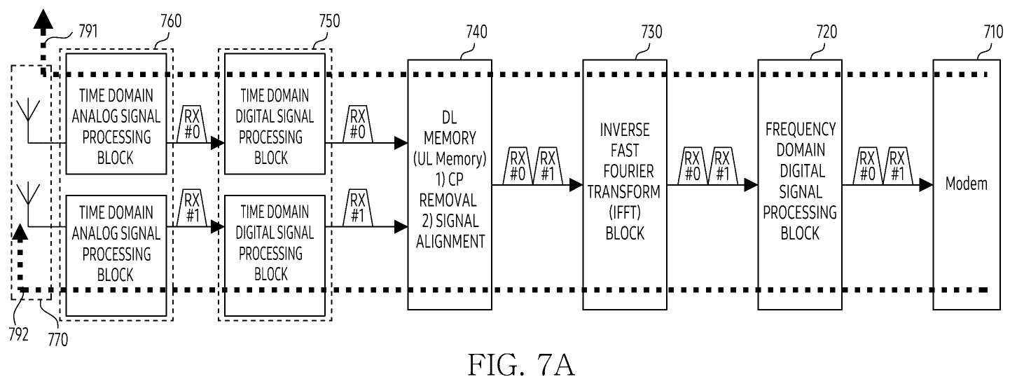

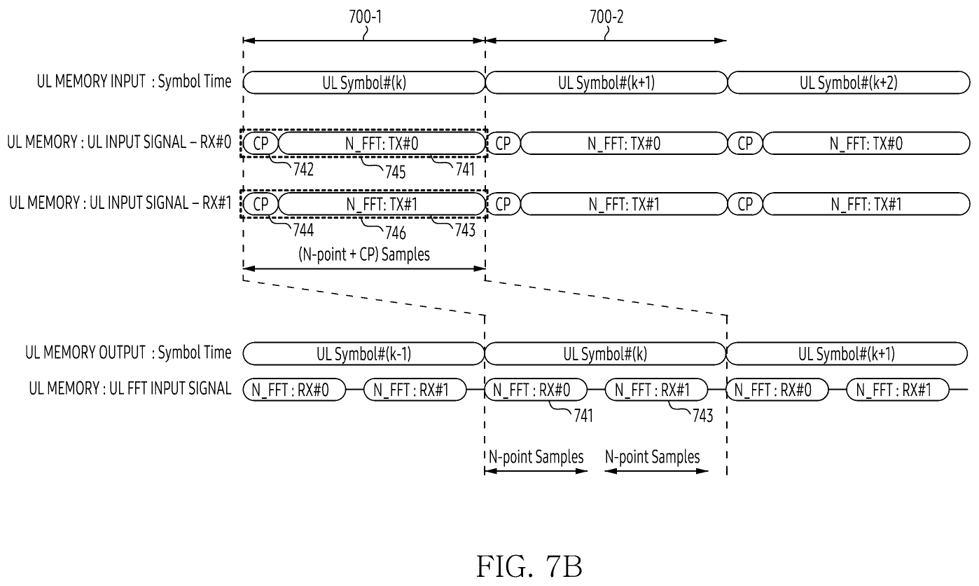

FIG. 7A is a diagram illustrating an example of functional blocks for UL signal transmission according to various embodiments.

FIG. 7B is a timing diagram illustrating an example operation of UL memory according to various embodiments.

Referring to FIG. 7A, a modem 710, a frequency domain digital signal processing block 720, a fast Fourier transform block 730, UL memory 740, a time domain digital signal processing block 750, a time domain analog signal processing block 760, and an antenna circuit 770 may be used for UL signal transmission.

At least a portion of the modem 710, the frequency domain digital signal processing block 720, the fast Fourier transform block 730, the UL memory 740, the time domain digital signal processing block 750, the time domain analog signal processing block 760, and the antenna circuit 770 may be included in the DU 210. A remaining portion of the modem 710, the frequency domain digital signal processing block 720, the fast Fourier transform block 730, the UL memory 740, the time domain digital signal processing block 750, the time domain analog signal processing block 760, and the antenna circuit 770 may be included in the RU 220.

Hereinafter, for convenience of description, it will be described that the modem 710 is included in the DU 210, the frequency domain digital signal processing block 720, the fast Fourier transform block 730, the UL memory 740, the time domain digital signal processing block 750, the time domain analog signal processing block 760, and the antenna circuit 770 are included in the RU 220. The DU 210 (or the processor 330 of the DU 210) may control the modem 710. The RU 220 (or the processor 380 of the RU 220) may control at least one of the frequency domain digital signal processing block 720, the fast Fourier transform block 730, the UL memory 740, the time domain digital signal processing block 750, the time domain analog signal processing block 760, and the antenna circuit 770.

When an operating clock frequency is twice as high as an UL sampling rate, an electrical path 791 and an electrical path 792 may be configured for a UL signal. For example, the UL memory 740 may have a two-path multiplexer (MUX) structure. Even when a size of the FFT is set to be half a size of the FFT according to two electrical paths, signals of all paths may be processed. Hereinafter, a timing diagram for indicating an operation of the UL memory 740 will be described with reference to FIG. 7B.

Referring to FIG. 7B, in the UL memory 740, a time interval 700-1 for an input of UL symbol #k may be set. An UL signal 745 and an UL signal 746 may be output from the time domain digital signal processing block 750 in the time interval 700-1. The UL signal 745 and the UL signal 746 may be stored in the UL memory 740 within the time interval 700-1. The UL signal 745 may include an FFT input signal 741 and a signal 742 that is a portion of the FFT input signal 741 set to the CP. The UL signal 746 may include an FFT input signal 743 and a signal 744 that is a portion of the FFT input signal 743 set to the CP.

In the UL memory 740, a time interval 700-2 for an output of UL symbol #k may be set. The time interval 700-2 for the output of the UL symbol #k may correspond to a time interval for an input of UL symbol #(k+1). The FFT input signal 741 and the FFT input signal 743 may be output from the UL memory 740 within the time interval 700-2.

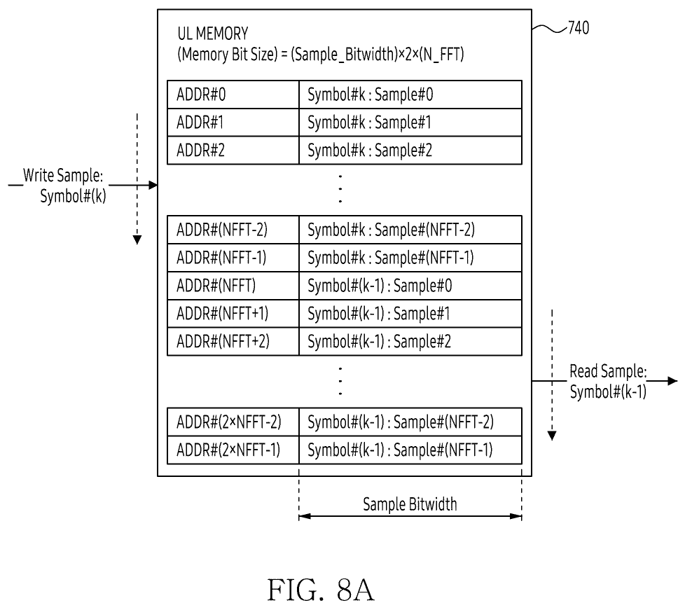

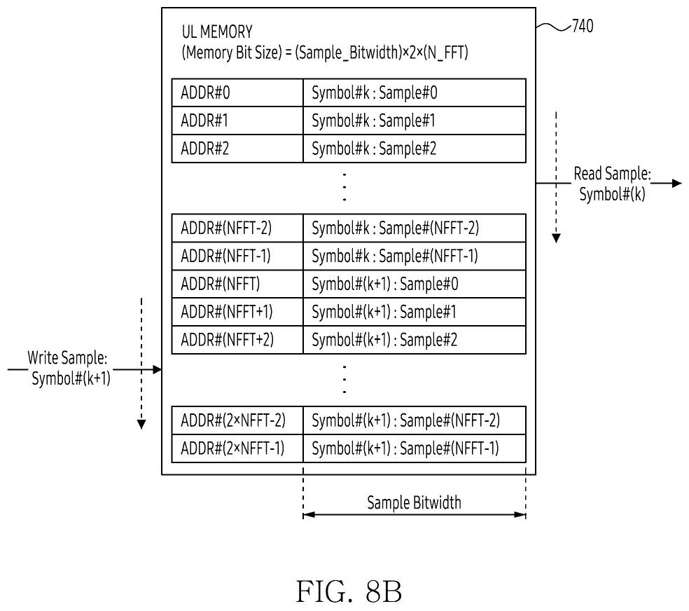

An operation of the UL memory 740 according to the above-described operation will be described in greater detail below with reference to FIGS. 8A and 8B.

FIG. 8A is a diagram illustrating an example operation of UL memory in symbol #k according to various embodiments.

FIG. 8B is a diagram illustrating an example operation of UL memory in symbol #(k+1) according to various embodiments.

Referring to FIG. 8A, the output of the digital signal processing block 750 may include time domain samples as large as a size of N-FFT at a time interval (e.g., the time interval 700-1 of FIG. 7B) set for the input of UL symbol #k in the UL memory 740. The output of the digital signal processing block 750 may further include time domain samples as large as a size of a cyclic prefix (CP). The UL memory 740 may store the FFT samples to input the FFT samples to the FFT after CP removal and path coupling (e.g., path MUX).

While the output of the digital signal processing block 750 is written (or stored) in the UL memory 740 at a time interval (e.g., the time interval 700-1 of FIG. 7B) set for an input of the UL symbol #k, samples written (or stored) at a time interval set for an input of UL symbol #(k−1) in the UL memory 740 may be read to be output to the fast Fourier transform block 730.

For example, the RU 220 (or the processor 380 of RU 220) may write, to the UL memory 740 output from the digital signal processing block 750, from address #0 (ADDR #0) to address #(NFFT−1) (ADDR #(NFFT−1)) of UL memory 740.

For example, the RU 220 may read data stored from address #(NFFT) (ADDR #(NFFT)) to address #(2×NFFT−1) (ADDR #(2×NFFT−1)) of the UL memory 740.

Referring to FIG. 8B, when the output of the digital signal processing block 750 corresponding to the UL symbol #(k+1) is written in the UL memory 740, samples written (or stored) at a time point corresponding to the UL symbol #k may be read to be output to the fast Fourier transform block 730.

For example, the RU 220 (or the processor 380 of RU 220) may write a signal output from the digital signal processing block 750 from address #(NFFT) (ADDR #(NFFT)) to address #(2×NFFT−1) (ADDR #(2×NFFT−1)) of the UL memory 740 to the UL memory 740.

For example, the RU 220 may read data stored from address #0 (ADDR #0) to address #(NFFT−1) (ADDR #(NFFT−1)) of the UL memory 740 to be output to the fast Fourier transform block 730.

Referring to FIGS. 8A and 8B, the UL memory 740 may operate based on a time delay of a length of one symbol. Accordingly, a bit-size of the UL memory 740 according to one antenna path may be set as shown in the following equation.

$$( U / L Memory Bit Size ) = ( Sample Bitwidth ) \times 2 \times ( N\_FFT ) \qquad [ Equation 2 ]$$

Referring to Equation 2, ‘UL Memory Bit Size’ may refer to a bit-size of the UL memory 740. ‘Sample Bitwidth’ may refer, for example, to a bit width of one FFT sample. ‘N_FFT’ may refer to a size of FFT.

Referring to Equation 1 and Equation 2 described above, the bit-size of the DL memory 540 and the UL memory 740 may be proportional to ‘Sample Bitwidth’ and ‘N_FFT’. The size of the DL memory 540 may correspond to the size of the UL memory 740. The size of the DL memory 540 may be the same as the size of the UL memory 740.

In addition, the size (or bit-size) of the DL memory 540 and the UL memory 740 according to Equation 1 and Equation 2 described above are set based on one path, so a larger memory size may be required when the number of antennas and the number of cells to be supported increase. The size of the memory considering the number of antennas and the number of cells to be supported may be set as shown in the following equation.

$$( Total Memory Bit Size ) = [ ( Sample Bitwidth ) \times 2 \times ( N\_FFT ) ] \times 2 ( = DL \& UL ) \times ( Paths ) \times ( Cells ) \qquad [ Equation 3 ]$$

Referring to Equation 3, ‘Total Memory Bit Size’ may refer to a bit-size of memory for UL and DL. ‘Sample Bitwidth’ may refer to a bit width of one FFT sample. ‘N_FFT’ may refer to a size of FFT. ‘Paths’ may refer, for example to the number of paths according to the number of antennas. ‘Cells’ may refer to the number of cells.

In order to support higher data throughput between a base station and a terminal in fifth generation (5G) communication system, MMU and/or RU may require support for larger FFT sizes and more antennas for MIMO operation compared to 3G system and 4G system.

Below, an example of an operation of functional blocks in a frequency division duplex (FDD) system and a time division duplex (TDD) system may be described.

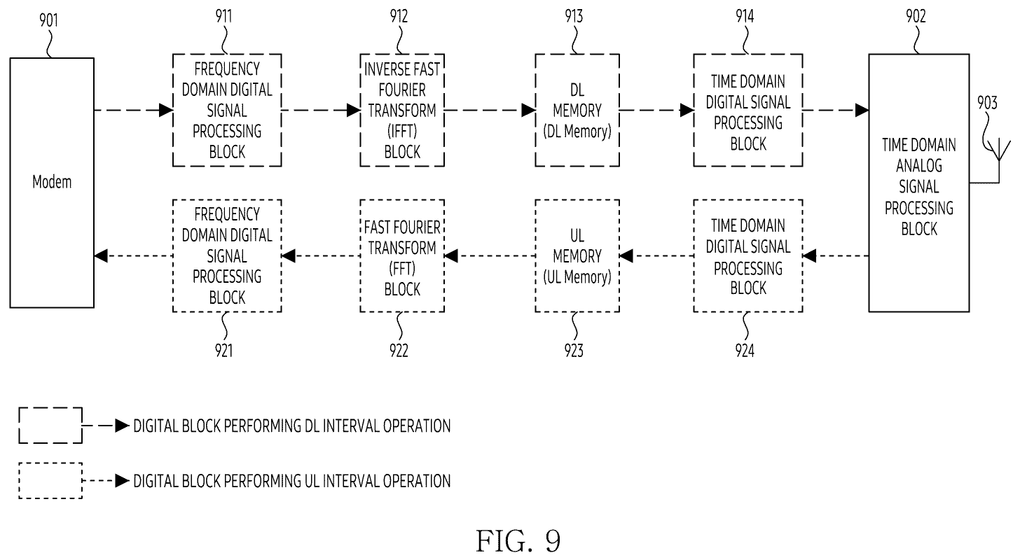

FIG. 9 is a diagram illustrating an example operation of functional blocks in an FDD system according to various embodiments.

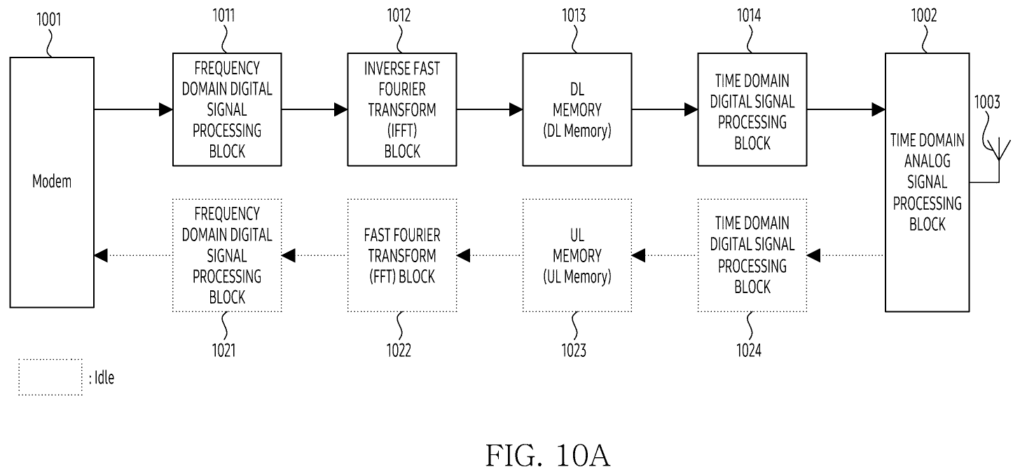

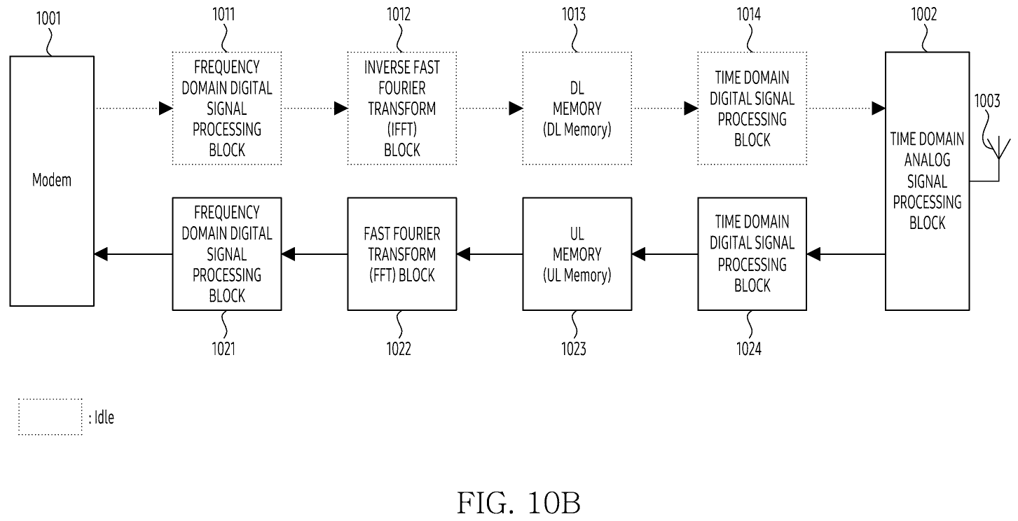

FIG. 10A is a diagram illustrating an example operation for DL of functional blocks in a TDD system according to various embodiments.

FIG. 10B is a diagram illustrating an example operation for UL of functional blocks in a TDD system according to various embodiments.

Referring to FIG. 9, in the FDD system, functional blocks of DL and UL paths may always operate because frequency bands for DL and UL are divided. Accordingly, the functional blocks of the DL and UL paths may not operate in an idle state. Since the functional blocks of the DL and UL paths do not operate in the idle state, functional blocks for DL and functional blocks for UL may be included in the FDD system.

For instance, for DL, a modem 901, a frequency domain digital signal processing block 911, an inverse fast Fourier transform block 912, DL memory 913, a time domain digital signal processing block 914, a time domain analog signal processing block 902, and an antenna circuit 903 may operate. For example, for UL, the antenna circuit 903, the time domain analog signal processing blocks 902, a time domain digital signal processing block 924, UL memory 923, a fast Fourier transform block 922, a frequency domain digital signal processing block 921, and the modem 901 may operate.

Referring to FIGS. 10A and 10B, in the TDD system, the same frequency band may be used for DL and UL. In the same frequency band, time intervals for DL and UL may be distinguished. Accordingly, at a time interval for DL operation, functional blocks for the UL may operate in the idle state. At a time interval for UL operation, functional blocks for the DL may operate in the idle state.

Referring to FIG. 10A, functional blocks for DL operation may operate in an active state within a time interval for DL. In the time interval for DL, functional blocks for UL operation may operate in an inactive state.

In the time interval for DL, a modem 1001, a frequency domain digital signal processing block 1011, an inverse fast Fourier transform block 1012, DL memory 1013, a time domain digital signal processing block 1014, a time domain analog signal processing block 1002, and an antenna circuit 1003 may operate in the active state.

In the time interval for DL, a time domain digital signal processing block 1024, UL memory 1023, a fast Fourier transform block 1022, and a frequency domain digital signal processing block 1021 may operate in the idle state.

Referring to FIG. 10B, functional blocks for UL operation may operate in the active state within the time interval for UL. Functional blocks for DL operation may operate in the inactive state within the time interval for UL.

In the time interval for UL, the antenna circuit 1003, the time domain analog signal processing block 1002, the time domain digital signal processing block 1024, the UL memory 1023, the fast Fourier transform block 1022, the frequency domain digital signal processing block 1021, and the modem 1001 may operate in the active state.

In the time interval for UL, the frequency domain digital signal processing block 1011, the inverse fast Fourier transform block 1012, the DL memory 1013, and the time domain digital signal processing block 1014 may operate in the idle state.

Referring to FIGS. 10A and 10B, the UL memory 1023 may not be used in the time interval for DL operation. The DL memory 1013 may not be used in the time interval for UL operation. Since the UL memory 1023 and the DL memory 1013 are alternately used, when both the UL memory 1023 and the DL memory 1013 are configured for the TDD system, hardware resource inefficiency may occur. As communication technology advances, MMU/RU requires a larger FFT size and a larger number of antennas, which may cause a problem in which the bit size of each of the UL memory 1023 and the DL memory 1013 increases exponentially. Therefore, in the following disclosure, a technical feature for improving the inefficiency of the UL memory 1023 and the DL memory 1013 in the TDD system will be described. In the following disclosure, a structure of time domain sample memory (TD memory) in which the UL memory 1023 and the DL memory 1013 are integrated and an operation of the TD memory will be described.

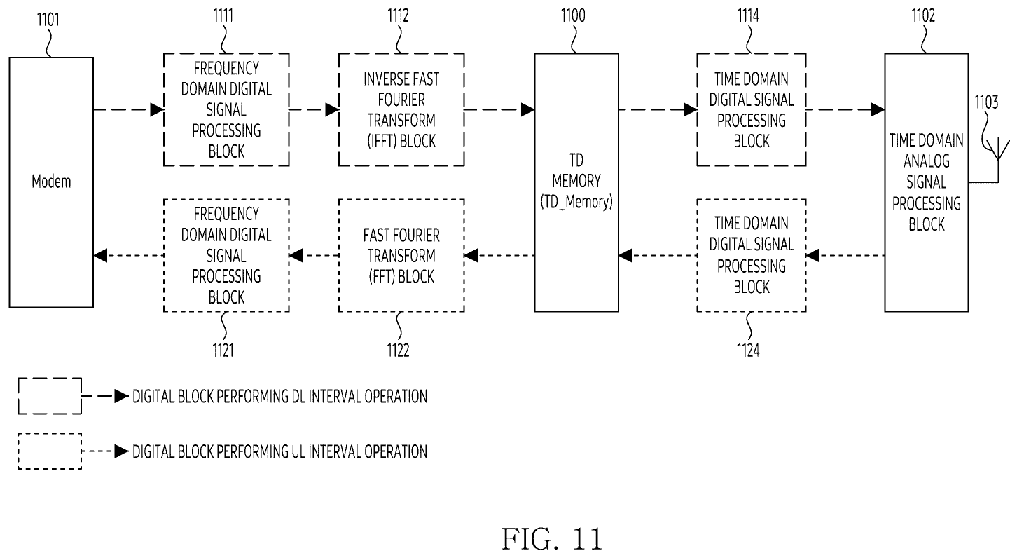

FIG. 11 is a diagram illustrating example functional blocks including TD memory according to various embodiments.

Referring to FIG. 11, since memory used for UL operation (e.g., the UL memory 1023 of FIGS. 10A and 10B) and memory used for DL operation (e.g., the DL memory 1013 of FIGS. 10A and 10B) are alternately used in the TDD systems, the memory used for UL operation and the memory used for DL operation may be configured with one TD memory 1100.

For instance, for DL, a modem 1101, a frequency domain digital signal processing block 1111, an inverse fast Fourier transform block 1112, TD memory 1100, a time domain digital signal processing block 1114, a time domain analog signal processing block 1102, and an antenna circuit 1103 may operate.

For example, for UL, an antenna circuit 1103, a time domain analog signal processing block 1102, a time domain digital signal processing block 1124, TD memory 1100, a fast Fourier transform block 1122, a frequency domain digital signal processing block 1121, and a modem 1101 may operate.

Hereinafter, in order to set the size of the TD memory 1100, in the TDD system, input data and output data of the TD memory 1100 over time will be described.

For convenience of description, an operation of the TD memory 1100 is described based on a new radio (NR) standard, but it is not limited thereto.

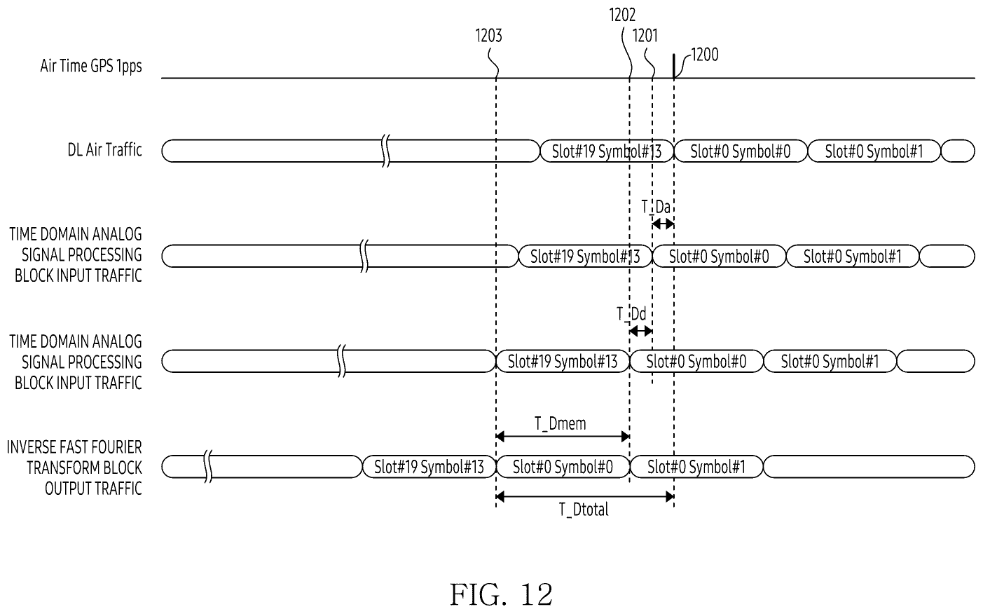

FIG. 12 is a diagram illustrating an example signal timing diagram of functional blocks for DL, in a time interval for a DL operation according to various embodiments.

Referring to FIGS. 11 and 12, a frame start point of a final DL traffic radiated through the antenna circuit 1103 should be synchronized with an air time global positioning system (GPS) synchronization signal (e.g., 1 pulse per second (PPS)). Therefore, considering a latency of functional blocks for DL, DL traffic should be applied to each functional block earlier than the synchronization signal.

DL transmission of symbol #0 of slot #0, which is radiated through the antenna circuit 1103, may be performed at a time point 1200. The latency of the time-domain analog signal processing block 1102 may be T_Da. A time point 1201, which is a traffic input time point for symbol #0 of the time domain analog signal processing block 1102, may precede the time point 1200 (or 1 PPS) by T_Da. For example, the time domain analog signal processing block 1102 may include at least one of a radio frequency integrated circuit (RFIC), an analog filter circuit, and a power amplifier circuit. For example, T_Da may be ‘r1’ [μs]. ‘r1’ may be a rational number.

The latency of the time-domain digital signal processing block 1114 may be T_Dd. A time point 1202, which is a traffic input time point for symbol #0 of the time-domain digital signal processing block 1114, may precede the time point 1201 by T_Dd. For example, the time domain digital signal processing block 1114 may include at least one of digital channel filter (DCF) circuitry, digital up converter (DUC) circuitry, crest factor reduction (CFR) circuitry, and digital pre-dister (DPD) circuitry. For example, T_Dd may be ‘r2’ [μs]. ‘r2’ may be a rational number.

The TD memory 1100 may operate in units of symbols. The output of the inverse fast Fourier transform block 1112 may correspond to the input of the TD memory 1100. The latency of the TD memory 1100 may be T_Dmem. A time point 1203, which is a traffic output time point for symbol #0 of the inverse fast Fourier transform block 1112, may precede the time point 1202 by T_Dmem. T_Dmem may correspond to a length of one symbol.

As described above, the traffic input time point of the TD memory 1100 may be a time point that precedes by T_Dtotal based on 1 pps. T_Dtotal may be set as shown in the following equation.

$$T\_Dtotal = T\_Dmem = T\_Dd + T\_Da = 1 Symbol = ( T\_Dd + T\_Da ) \qquad [ Equation 4 ]$$

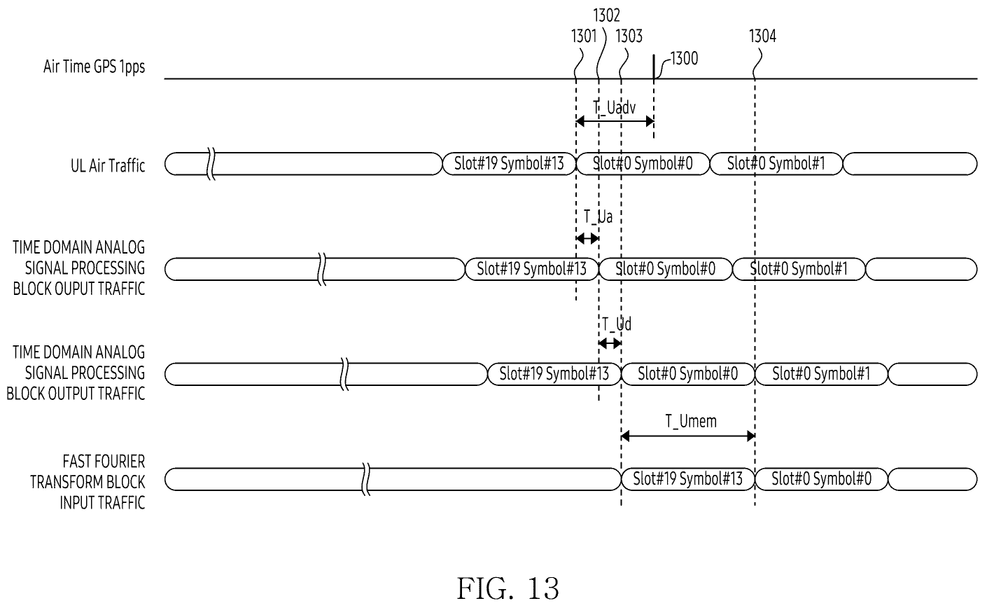

FIG. 13 is a signal timing diagram of functional blocks for UL, in a time interval for UL operation according to various embodiments.

Referring to FIGS. 11 and 13, the frame start point of UL traffic input (or obtained) through the antenna circuit 1103 may precede an air time GPS synchronization signal (e.g., 1 pulse per second (PPS)) by a designated time. For example, in communication systems supporting the NR specification (e.g., subcarrier spacing (SCS) 30 kHz), the designated time may be set to 13.02 [μs]. For example, in a communication system supporting the LTE standard (e.g., SCS 15 kHz), the designated time may be set to 20.31 [μs]. For example, in a communication system supporting both the NR standard and the long term evolution (LTE) standard, the designated time may be set to 20.31 [μs]. The designated time interval may be set as N_{TA offset}×T_{c}. N_{TA offset} and T_{c} may be set as shown in Table 1 and Table 2 within the 3GPP standard.

TABLE 1
The UE shall meet the Te requirement for an initial transmission provided that at least
one SSB is available at the UE during the last 160 ms. The reference point for the UE
initial transmit timing control requirement shall be the downlink timing of the reference
cell minus. (N_{TA} + N_{TA offset}) × T_{c} The downlink timing is defined as the time when
the first detected path (in time) of the corresponding downlink frame is received from
the reference cell. N_{TA} for PRACH is defined as 0.
(N_{TA} + N_{TA offset}) × T_{c} (in T_{c} units) for other channels is the difference between UE
transmission timing and the downlink timing immediately after when the last timing
advance in clause 7.3 was applied. N_{TA} for other channels is not changed until next
timing advance is received. The value of N_{TA offset} depends on the duplex mode of the
cell in which the uplink transmission takes place and the frequency range (FR).
N_{TA offset} is defined in Table 2.
Note:
T_{c} = 1/(480 kHz · 4096) = 0.509 ns

TABLE 2

| Frequency range and band of cell | |
|---|---|
| used for uplink transmission | N_{TA} offset (Unit: Tc) |
| FDD in FR1 | 0 |
| FR1 TDD band | 39936 or 25600 (Note 1) |
| FR2 | 13792 |

(NOTE 1):
The UE identifies N_{TA offset} based on the information [TBD] according to [TS38.331].
NOTE 2:
The value of N_{TA offset} that applies to the supplementary UL carrier is determined from the non-supplementary UL carrier.

Referring to Table 1 and Table 2, N_{TA} may be set based on a timing advance (TA) command received through a random access response message or a TA command received through MAC control elements (CE).

The above-described designated time may be T_Uadv. A time point 1301, which is a frame start time point of UL traffic, may precede the time point 1300 based on an air time GPS synchronization signal (e.g., 1 pulse per second (PPS)) by T_Uadv.

The latency of the time-domain analog signal processing block 1102 may be T_Ua. A time point 1302, which is a traffic output time point for symbol #0 of the time-domain analog signal processing block 1102, may precede the time point 1300 (or 1 PPS) by T_Uadv-T_Ua. For example, the time domain analog signal processing block 1102 may include at least one of a low noise amplifier (LNA) circuit, analog filter circuitry, and an RFIC circuit. For example, T_Ua may be ‘r3’ [μs]. ‘r3’ may be a rational number.

The latency of the time domain digital signal processing block 1124 may be T_Ud. A time point 1303, which is a traffic output time point for symbol #0 of the time domain digital signal processing block 1124, may be delayed by T_Ud from the time point 1302. For example, the time domain digital signal processing block 1124 may include at least one of digital down converter (DDC) circuitry and digital channel filter (DCF) circuitry. For example, T_Ud may be ‘r4’ [μs]. ‘r4’ may be a rational number.

The TD memory 1100 may operate in units of symbols. An input of the fast Fourier transform block 1122 may correspond to an output of the TD memory 1100. The latency of the TD memory 1100 may be T_Umem. A time point 1304, which is a traffic input time point for symbol #0 of the fast Fourier transform block 1122, may be delayed by T_Umem from the time point 1303. T_Umem may correspond to a length of one symbol.

As described above, the traffic input time point of the TD memory 1100 may be a time point that precedes by T_Utotal based on 1 pps. T_Utotal may be set as shown in the following equation.

$$T\_Utotal = T\_Uadv - ( T\_Ua + T\_Ud ) \qquad [ Equation 5 ]$$

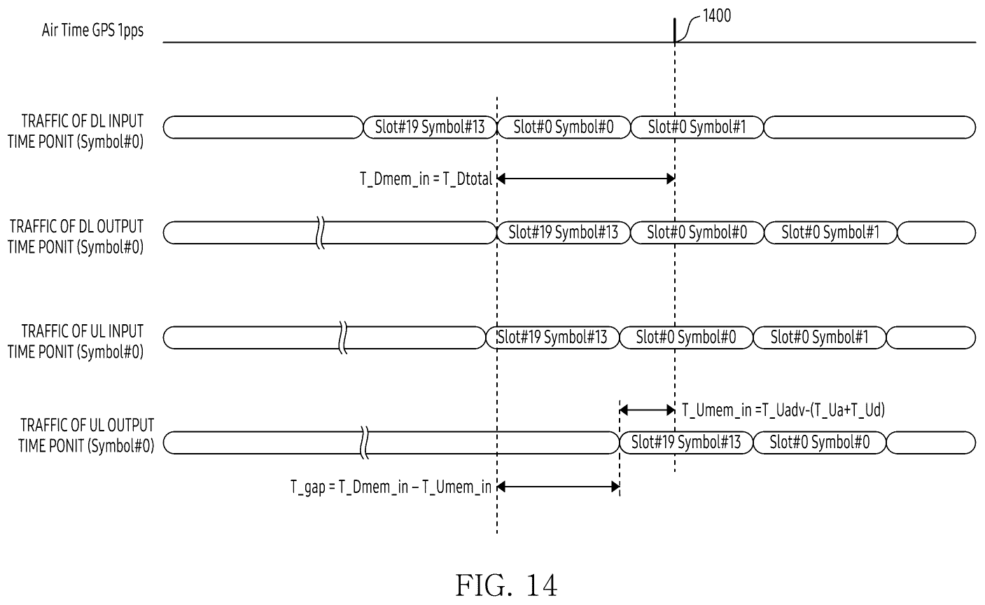

FIG. 14 is a signal timing diagram in a time interval for an UL operation and a time interval for a DL operation according to various embodiments.

Referring to FIG. 14, FIG. 14 illustrates an input time point of DL traffic and an input time point of UL traffic in the TD memory 1100 of FIGS. 12 and 13.

The input time point of DL traffic in the TD memory 1100 may precede a time point 1400 based on an air time GPS synchronization signal (e.g., 1 pulse per second (PPS)) by T_Dmen_in. The input time point of UL traffic in the TD memory 1100 may precede the time point 1400 based on an air time GPS synchronization signal (e.g., 1 pulse per second (PPS)) by T_Umen_in.

A time difference between the input time point of the DL traffic in the TD memory 1100 and the input time point of the UL traffic in the memory 1100 may be set as shown in the following equation.

$$T\_gap = T\_Dmem \_in - T\_Umem \_in = ( 1 Symbol + T\_Dd + T\_Da ) - \{ T\_Uadv - T\_Ua + T\_Ud ) \} = 1 Symbol - T\_Uadv + T\_td \_dly ( T\_td \_dly = T\_Da + T\_Dd + T\_Ua + T\_Ud ) \qquad [ Equation 6 ]$$

Referring to Equation 6, ‘T_gap’ may refer to a time difference between the input time point of the DL traffic in the TD memory 1100 and the input time point of the UL traffic in the memory 1100. ‘T_td_dly’ may refer, for example, to a sum of the latency from the antenna circuit 1103 to the TD memory 1100 on the UL path and the latency from the TD memory 1100 to the antenna circuit 1103 on the DL path. For example, ‘T_td_dly’ may be ‘r5’ [μs]. ‘r5’ may be a rational number.

Hereinafter, a technical feature for setting a size of the TD memory 1100 based on T_gap identified in a flexible slot (F-slot) operating from UL to DL and operating from DL to UL within the TDD system will be described.

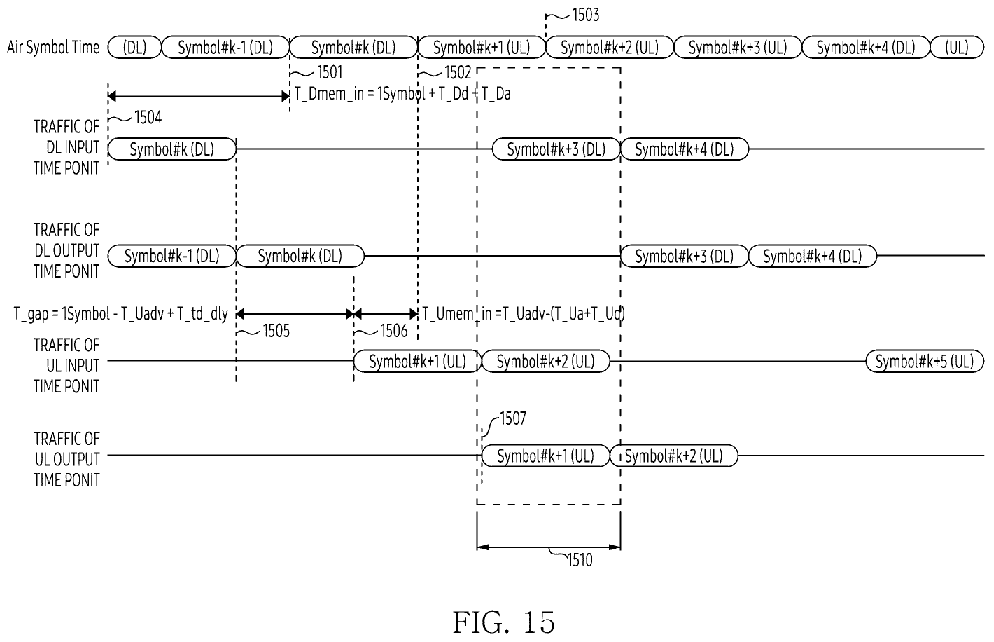

FIG. 15 is a signal timing diagram of TD memory, according to DL traffic and UL traffic in an F-slot according to various embodiments.

Referring to FIG. 15, DL traffic may be transmitted in symbol #k. UL traffic may be received in symbol #(k+1). UL traffic may be received in symbol #(k+2).

For example, a frame of symbol #k may start at a time point 1501, which is a time point based on an air time GPS synchronization signal (e.g., 1 pulse per second (PPS)). At a time point 1502, which is a time point based on an air time GPS synchronization signal (e.g., 1 pulse per second (PPS)), a frame of symbol #(k+1) may start. At a time point 1503, which is a time point based on an air time GPS synchronization signal (e.g., 1 pulse per second (PPS)), a frame of symbol #(k+2) may start.

DL traffic according to symbol #k may be input to the TD memory 1100 at a time point 1504. The time point 1504 may precede the time point 1501 by T_Dmem_in. DL traffic according to symbol #k may be output from the TD memory 1100 at a time point 1505.

UL traffic according to symbol #(k+1) may be input to the TD memory 1100 at a time point 1506. The time point 1506 may precede the time point 1502 by T_Umem_in. UL traffic according to symbol #(k+1) may be output from the TD memory 1100 at the time point 1507.

For example, According to a size of T gap, which is a value obtained by subtracting T_Umem_in from T_Dmem_in, DL traffic and UL traffic may overlap. In a time interval 1510, while DL traffic according to symbol #(k+3) is input to the TD memory 1100, UL traffic according to symbol #(k+1) may be output in the TD memory 1100, and UL traffic according to symbol #(k+2) may be input in the TD memory 1100. Therefore, three UL/DL symbol data may be simultaneously input and output in the TD memory 1100. The size of the TD memory 1100 required in the time interval 1510 should be set to process three symbol data.

Hereinafter, a range of T_gap may be identified. In order to identify the range of T_gap, two conditions may be used. Two conditions will be described first.

First condition: T_Uadv does not exceed a length of one symbol.

Regarding the first condition, a last DL symbol of a DL-UL change interval in the TDD system may be set as a gap symbol. Therefore, DL traffic does not exist in a last DL symbol. The DL traffic does not exist in a last DL symbol, because T_Uadv is applied. When T_Uadv exceeds the length of one symbol, a time interval for which DL traffic is transmitted and a time interval for which UL traffic is transmitted may overlap in air symbol time. When the time interval for which DL traffic is transmitted and the time interval for which UL traffic is transmitted overlap, the TDD system may not operate. T_Uadv may be set differently in a communication system supporting the NR standard, a communication system supporting the LTE standard, and a communication system supporting both the NR standard and the LTE standard. Examples of T_Uadv in the communication system supporting the NR standard, the communication system supporting the LTE standard, and the communication system supporting both the NR standard and the LTE standard may be set as shown in Table 3.

TABLE 3

| Tech | Symbol Time [μs] | T_Uadv [μs] | Symbol − T_Uadv [μs] |
|---|---|---|---|
| NR | 35.677 | 13.02 | 22.657 |
| LTE | 71.354 | 20.31 | 51.044 |
| NR + LTE | 35.677 (MIN) | 20.31(MAX) | 15.367 |

Referring to Table 3, in the communication system of the NR standard, sub-carrier spacing may be set to 30 kHz. In the communication system of the LTE standard, sub-carrier spacing may be set to 15 kHz.

Second condition: T_td_dly is greater than 0.

Regarding the second condition, since T_td_dly according to Equation 6 described above is the sum of latencies of physically implemented functional blocks, T_td_dly is greater than 0. For example, functional blocks related to latencies (e.g., T_Da, T_Dd, T_Ua, and T_Ud) configuring T_td_dly do not operate in units of symbols. Therefore, T_td_dly may have a value ranging from several microseconds (μs) to several tens of microseconds (μs).

When T_td_dly has a value within a maximum T_Uadv, the range of T_gap may be set as shown in the following equation.

$$0 < T\_td \_dly < T\_Uadv \qquad [ Equation 7 ]$$

$$1 symbol - T\_Uadv < T\_gap < 1 Symbol \qquad [ Equation 8 ]$$

Hereinafter, when the range of T_gap is set as shown in Equation 8, the size of the TD memory 1100 required according to each time point of the F-slot may be described.

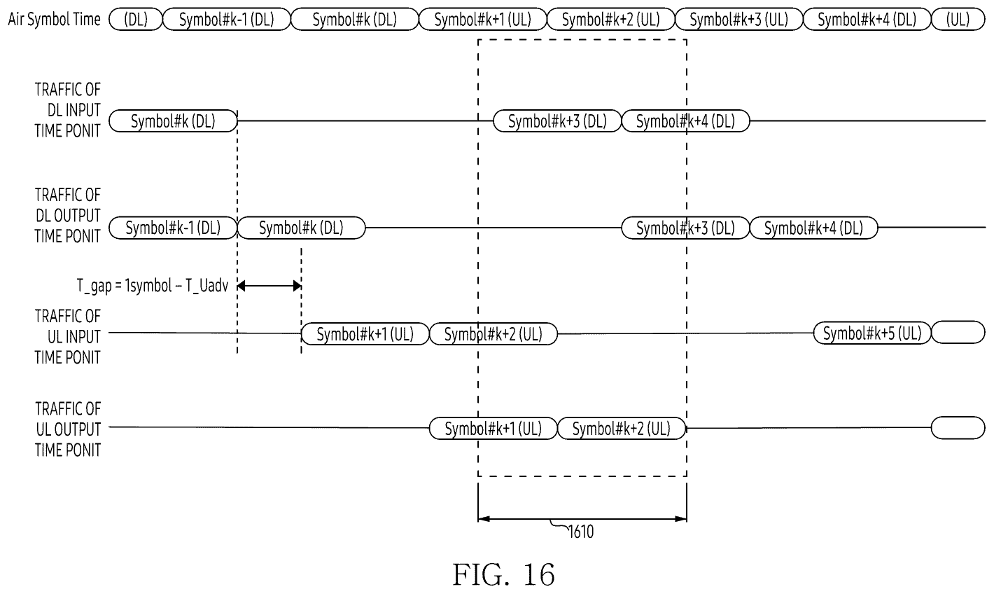

FIG. 16 is a signal timing diagram of TD memory, according to DL traffic and UL traffic in an F-slot according to various embodiments.

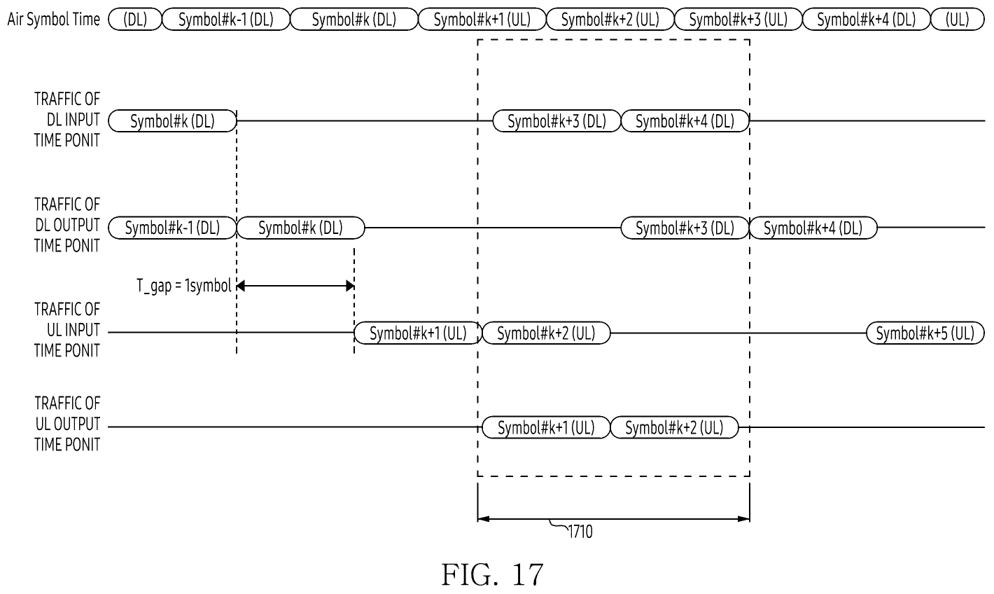

FIG. 17 is a signal timing diagram of TD memory, according to DL traffic and UL traffic in an F-slot according to various embodiments.

Referring to FIG. 16, T_gap may be set as shown in the following equation.

$$T\_gap = 1 symbol - T\_Uadv \qquad [ Equation 9 ]$$

When T_gap is set as shown in Equation 9, an operation of the TDD system may be supported by a memory size capable of processing three symbol data in a time interval 1610. Therefore, the size of the TD memory 1100 may be set to a size capable of processing three symbol data.

Referring to FIG. 17, T_gap may be set to one symbol length. When T_gap is set to one symbol length, an operation of the TDD system may be supported only by a memory size capable of processing three symbol data in a time interval 1710. Therefore, the size of the TD memory 1100 may be set to a size capable of processing three symbol data.

Referring to FIGS. 16 and 17, within the range of T_gap according to Equation 8, the time interval 1610 and the time interval 1710, in which use of the TD memory 1100 is the maximum, may be identified. In both the time interval 1610 and the time interval 1710, the operation of the TDD system may be supported only by a memory size capable of processing three symbol data. Therefore, the size of the TD memory 1100 may be reduced by 25% compared to a size of the entire memory when the DL memory and the UL memory are configured individually as in FIGS. 10A and 10B.

The size of the TD memory 1100 for supporting the TDD system may be set as shown in the following equation.

$$( Total Memory Bit Size ) = [ ( Sample Bitwidth ) \times ( N\_FFT ) ] \times 3 \times ( Paths ) \times ( Cells ) \qquad [ Equation 10 ]$$

Referring to Equation 10, ‘Total Memory Bit Size’ may refer to a bit-size of the TD memory 1100. ‘Sample Bitwidth’ may refer to a bit width of one FFT sample. ‘N_FFT’ may refer to a size of FFT. ‘Paths’ may refer, for example, to the number of paths according to the number of antennas. ‘Cells’ may refer to the number of cells.

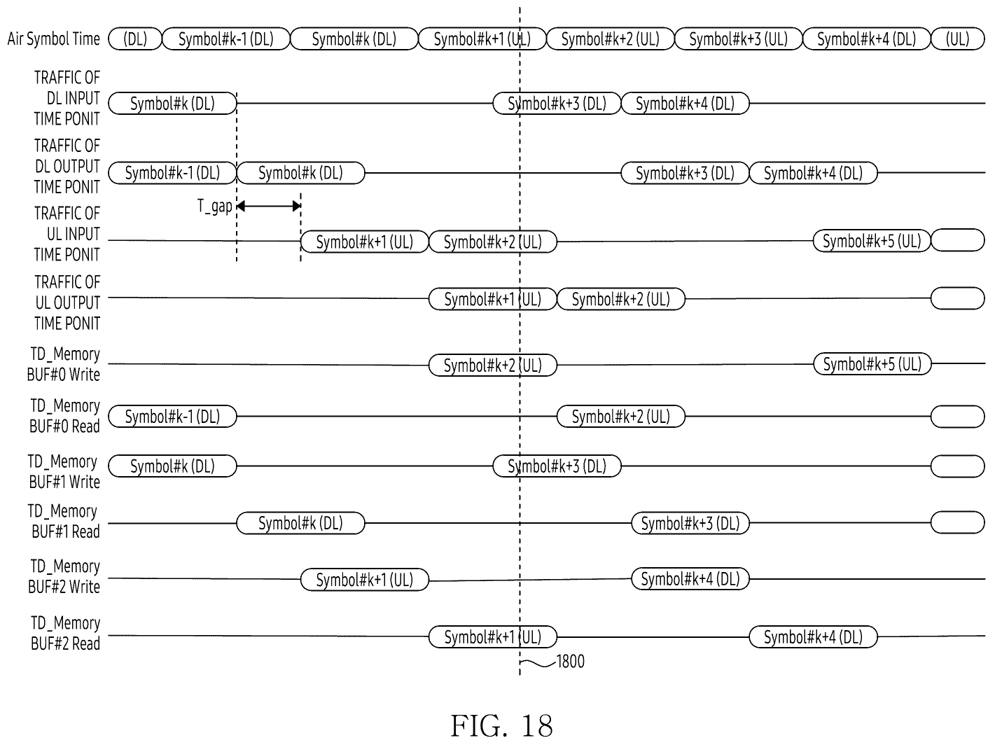

FIG. 18 is a signal timing diagram of TD memory, according to DL traffic and UL traffic in an F-slot according to various embodiments.

Referring to FIG. 18, the operation of the TDD system may be supported only by a memory size capable of processing three symbol data, and thus the TD memory 1100 may include three buffers. One of the three buffers may be configured to process traffic for one symbol.

For example, UL traffic according to symbol #(k+1) may be output from the TD memory 1100 at a time point 1800. As UL traffic according to symbol #(k+1) is read from a first buffer BUF #0 of the TD memory 1100, UL traffic may be output from the memory 1100.

UL traffic according to symbol #(k+2) may be input (or stored) to the TD memory 1100 at the time point 1800. As UL traffic according to symbol #(k+1) is written in a second buffer BUF #1 of the TD memory 1100, UL traffic may be input (or stored) in the memory 1100.

DL traffic according to symbol #(k+3) may be input to the TD memory 1100 at the time point 1800. As DL traffic according to symbol #(k+2) is written in a third buffer BUF #2 of the TD memory 1100, DL traffic may be input (or stored) in the memory 1100.

Hereinafter, an example of a configuration of the TD memory 1100 and an operation according to the configuration of the TD memory 1100 will be described.

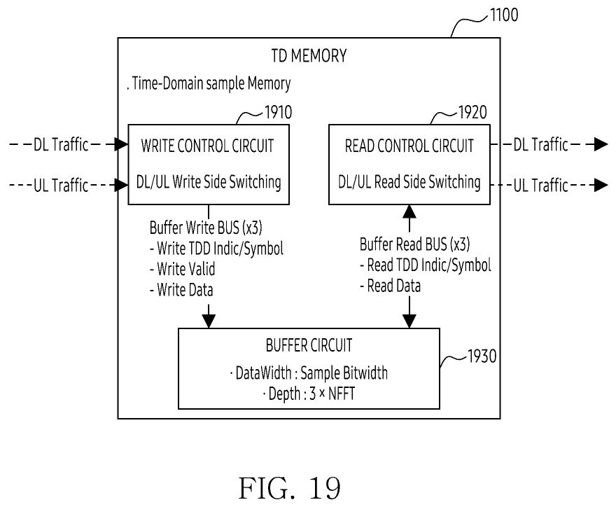

FIG. 19 is a diagram illustrating example circuits included in TD memory according to various embodiments.

Referring to FIG. 19, the TD memory 1100 may include a write control circuit 1910, a read control circuit 1920, and a buffer circuit 1930.

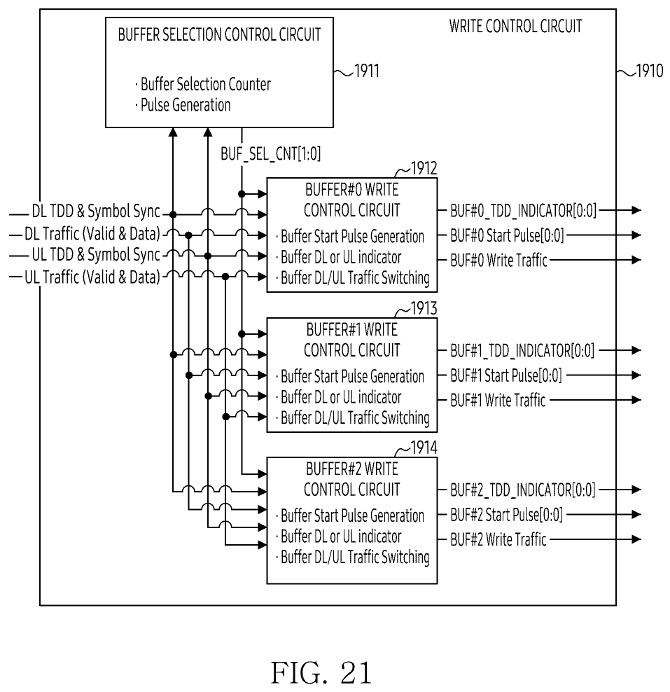

For example, the write control circuit 1910 may control data written in the buffer circuit 1930 to be set as DL traffic at a DL operation time. The write control circuit 1910 may control (e.g., switching) data written in the buffer circuit 1930 to be set as UL traffic at an UL operation time. As an example, the write control circuit 1910 may be referred to as ‘TDD_BUF_WRCTRL (TDD buffer write control)’. Examples of configuration and operation of the write control circuit 1910 will be described in greater detail below with reference to FIGS. 21 to 24.

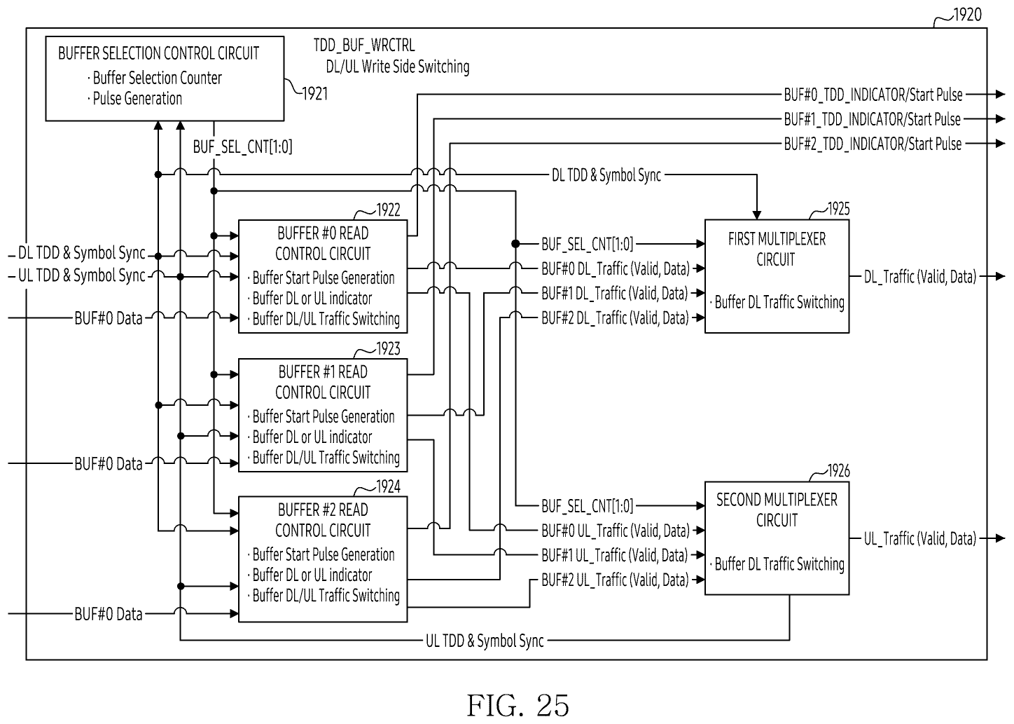

For example, the read control circuit 1920 may control data read in the buffer circuit 1930 to be set as DL traffic at a DL operation time. The read control circuit 1910 may control (e.g., switching) data read in the buffer circuit 1930 to be set as UL traffic at an UL operation time. As an example, the read control circuit 1920 may be referred to ‘TDD_BUF_RDCTRL (TDD buffer read control)’. Examples of the configuration and operation of the read control circuit 1920 will be described in greater detail below with reference to FIGS. 25 to 28.

For example, the buffer circuit 1930 may be used to store sample data in the time domain in units of symbols. Based on the control signal received from the write control circuit 1910, the buffer circuit 1930 may store DL traffic and/or UL traffic.

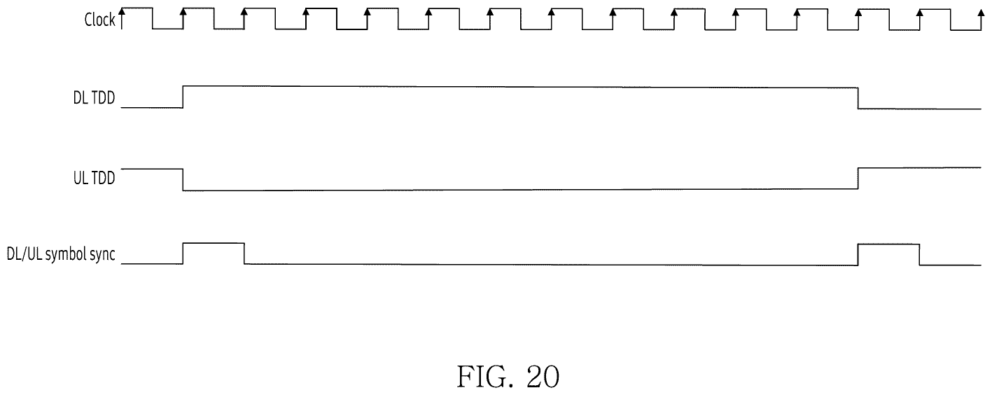

Hereinafter, an example of an operation of circuits included in the above-described TD memory 1100 will be described. First, signals used for the operation of the TD memory 1100 will be described with reference to FIG. 20.

FIG. 20 is a timing diagram illustrating signals used for an operation of TD memory according to various embodiments.

Referring to FIG. 20, a clock signal may be generated based on a designated period. The clock signal may be used to set an operation timing of the TD memory 1100.

A DL TDD signal may be used for indicating a DL operation in the TDD system. For example, when the DL TDD signal is a first value (e.g., 1), it may indicate that the DL operation is performed. When the DL TDD signal is a second value (e.g., 0), it may indicate that the DL operation is not performed.

A UL TDD signal may be used for indicating an UL operation in the TDD system. For example, when the UL TDD signal is a first value (e.g., 1), it may indicate that the UL operation is performed. When the UL TDD signal is a second value (e.g., 0), it may indicate that the UL operation is not performed.

The DL/UL synchronization (sync) signal may be used to indicate a change in DL or

UL. In FIG. 20, the DL/UL sync signal is illustrated as one, but according to an embodiment, a DL symbol sync signal for the DL TDD signal and a UL symbol sync signal for the UL TDD signal may be configured.

FIG. 21 is a diagram illustrating an example configuration of a write control circuit included in TD memory according to various embodiments.

Referring to FIG. 21, a DL TDD signal, a DL symbol synchronization (sync) signal, a DL traffic signal, a UL TDD signal, a UL symbol sync signal, and a UL traffic signal may be set as input signals of a write control circuit 1910.

BUF #0_TDD_INDICATOR signal, BUF #0 start pulse signal, BUF #0 write traffic signal, BUF #1_TDD_INDICATOR signal, BUF #1 start pulse signal, BUF #1 write traffic signal, BUF #2_TDD_INDICATOR signal, BUF #2 start pulse signal, and BUF #2 write traffic signal may be set as output signals of the write control circuit 1910.

For example, each of the BUF #0_TDD_INDICATOR signal, the BUF #1_TDD_INDICATOR signal, and the BUF #2_TDD_INDICATOR signal may be configured with 1 bit.

For example, each of the BUF #0 start pulse signal, the BUF #1 start pulse signal, and the BUF #2 start pulse signal may be configured with 1 bit.

The write control circuit 1910 may include a buffer selection control circuit 1911, a buffer #0 write control circuit 1912, a buffer #1 write control circuit 1913, and a buffer #2 write control circuit 1914.

The buffer selection control circuit 1911 may generate BUF_SEL_CNT signal. The BUF_SEL_CNT signal may be used to select one of three buffers. The BUF_SEL_CNT signal may be configured with 2 bits.

The buffer #0 write control circuit 1912 may generate (or output) BUF #0_TDD_INDICATOR signal, BUF #0 start pulse signal, and BUF #0 write traffic signal, based on BUF_SEL_CNT signal, DL TDD signal, DL symbol sync signal, DL traffic signal, UL TDD signal, UL symbol sync signal, and UL traffic signal.

The buffer #1 write control circuit 1913 may generate (or output) BUF #1_TDD_INDICATOR signal, BUF #1 start pulse signal, and BUF #1 write traffic signal, based on BUF_SEL_CNT signal, DL TDD signal, DL symbol sync signal, DL traffic signal, UL TDD signal, UL symbol sync signal, and UL traffic signal.

The buffer #2 write control circuit 1914 may generate (or output) BUF #2_TDD_INDICATOR signal, BUF #2 start pulse signal, and BUF #2 write traffic signal, based on BUF_SEL_CNT signal, DL TDD signal, DL symbol sync signal, DL traffic signal, UL TDD signal, UL symbol sync signal, and UL traffic signal.

The write control circuit 1910 may transmit DL traffic and/or UL traffic to be input (or written) to each of the three buffers included in the TD memory 1100, based on symbol timing information and TDD information (e.g., DL TDD signal or UL TDD signal) at an input point (or a write point) according to DL and/or UL operation. The write control circuit 1910 may transmit TDD information to the three buffers (or one of the three buffers) so that a write operation may be performed according to a DL timing and/or an UL timing.

For example, the write control circuit 1910 may transmit DL traffic to one of the three buffers at an input time according to the DL operation. For example, the write control circuit 1910 may transmit UL traffic to one of the three buffers at an input time according to the UL operation.

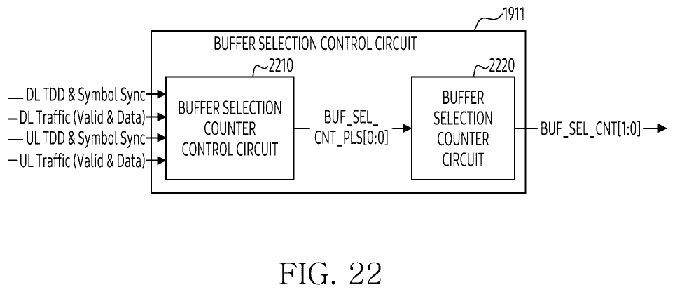

FIG. 22 is a diagram illustrating an example configuration of a buffer selection control circuit included in a write control circuit according to various embodiments.

Referring to FIG. 22, the DL TDD signal, the DL symbol sync signal, the UL TDD signal, and the UL symbol sync signal may be set as input signals of the buffer selection control circuit 1911. The BUF_SEL_CNT signal may be set as an output signal of the buffer selection control circuit 1911. The BUF_SEL_CNT signal may be configured with 2 bits.

The buffer selection control circuit 1911 may generate a buffer index of a buffer to be switched, based on DL TDD signal, UL TDD signal, DL symbol sync signal, and UL symbol sync signal. The symbol sync signal of the DL interval or the UL interval may be used to trigger a buffer selection counter circuit. The BUF_SEL_CNT signal may be set to one of three values, ‘0’, ‘1’, and ‘2’, based on the number of buffers included in the TD memory 1100.

For example, the buffer selection control circuit 1911 may include a buffer selection counter control circuit 2210 and a buffer selection counter circuit 2220.

The buffer selection counter control circuit 2210 may generate (or output) BUF_SEL_CNT_PLS signal, based on DL TDD signal, UL TDD signal, DL symbol sync signal, and UL symbol sync signal. For example, the BUF_SEL_CNT_PLS signal may be configured with 1 bit. The BUF_SEL_CNT_PLS signal may be used to control the buffer selection counter circuit 2220. The buffer selection counter control circuit 2210 may operate based on the table below.

TABLE 4

| Input | | | | |
|---|---|---|---|---|
| DL | DL | UL | UL | Output |
| TDD | symbol sync | TDD | symbol sync | BUF_SEL_CNT_PLS |
| 1′b1 | 1′b1 | 1'b0 | 1′bX | 1′b1 |
| 1′b1 | 1′b1 | 1′b1 | 1′b1 | 1′b1 |
| 1′b0 | 1′bX | 1′b1 | 1′b1 | 1′b1 |
| 1′b1 | 1′b1 | 1′b1 | 1′b0 | 1′b1 |

| | |
|---|---|
| Others | 1′b0 |

Referring to Table 4, when DL TDD signal, UL TDD signal, DL symbol sync signal, and UL symbol sync signal are set as input signals, the BUF_SEL_CNT_PLS signal may be output. X may refer to ‘Don't care’.

The buffer selection counter circuit 2220 may generate (or output) BUF_SEL_CNT signal, based on the BUF_SEL_CNT_PLS signal. The buffer selection counter circuit 2220 may be set to operate based on a designated algorithm. The designated algorithm may be set as shown in the table below.

TABLE 5

```
If(BUF_SEL_CNT_PLS == 1′b1)
  If(BUF_SEL_CNT == 2′d2)
    BUF_SEL_CNT <= 2′d0
  else
    BUF_SEL_CNT <= BUF_SEL_CNT + 2′d1
else
BUF_SEL_CNT <= BUF_SEL_CNT
```

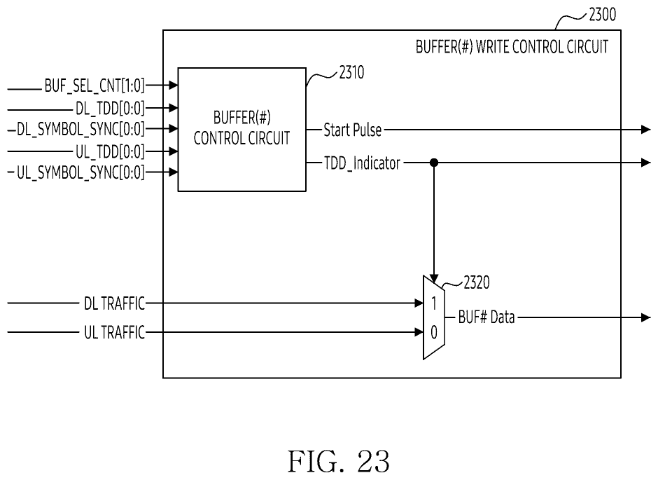

FIG. 23 is a diagram illustrating an example configuration of a buffer write control circuit included in a write control circuit according to various embodiments.

Referring to FIG. 23, a buffer (#) write control circuit 2300 may be an example of the buffer #0 write control circuit 1912, the buffer #2 write control circuit 1914, the buffer #1 write control circuit 1913, and the buffer #2 write control circuit 1914.

For example, in the buffer (#) write control circuit 2300, ‘#’ may refer to a buffer index. When ‘#’ is set to ‘0’, the buffer (#) write control circuit 2300 may operate as a buffer #0 write control circuit 1912. When ‘#’ is set to ‘1’, the buffer (#) write control circuit 2300 may operate as a buffer #1 write control circuit 1913. When ‘#’ is set to ‘2’, the buffer (#) write control circuit 2300 may operate as a buffer #2 write control circuit 1914.

A BUF_SEL_CNT signal, a DL TDD signal, a DL symbol sync signal, a UL TDD signal, a UL symbol sync signal, a DL traffic signal, and a UL traffic signal may be set as an input signal of the buffer (#) write control circuit 2300.

A start pulse signal (e.g., BUF #0 start pulse signal, BUF #1 start pulse signal, and BUF #2 start pulse signal of FIG. 21), a TDD_INDICATOR signal (e.g., BUF #0_TDD_INDICATOR signal, BUF #1_TDD_INDICATOR signal, and BUF #2_TDD_INDICATOR signal of FIG. 21), and a BUF (#) write traffic signal (e.g., BUF #0 write traffic signal, BUF #1 write traffic signal, and BUF #2 write traffic signal of FIG. 21) may be set as an output signal of the buffer (#) write control circuit 2300.

Based on a match of the BUF_SEL_CNT signal and the buffer index (#) (or index of the buffer write control circuit), the buffer (#) write control circuit 2300 may generate a TDD_INDICATOR signal and a start pulse signal for each buffer using the UL TDD signal, the DL TDD signal, the UL symbol sync signal, and the DL symbol sync signal.

The buffer (#) writing control circuit 2300 may set one of DL traffic and UL traffic as data to be input to each buffer, through the TDD_INDICATOR signal.

The buffer (#) write control circuit 2300 may include a buffer (#) control circuit 2310 and a multiplexer 2320.

The buffer (#) control circuit 2310 may generate (or output) the TDD_INDICATOR signal and the start pulse signal, based on the BUF_SEL_CNT signal, the DL TDD signal, the UL TDD signal, the DL symbol sync signal, and the UL symbol sync signal. The buffer (#) control circuit 2310 may operate based on the table below.

TABLE 6

| Input | | | | | | | |
|---|---|---|---|---|---|---|---|
| | DL | | UL | | | | |
| DL | symbol | UL | symbol | | | Output | |
| TDD | sync | TDD | sync | BUF_SEL_CNT_PLS | BUF_SEL_CNT | TDD_INDICATOR | Start Pulse |
| 1′b1 | 1′b1 | 1′b0 | 1′bX | 1′b1 | 2′d# | 1′b1 | 1′b1 |
| 1′b1 | 1′b0 | 1′b1 | 1′b1 | 1′b1 | 2′d# | 1′b0 | 1′b1 |
| 1′b0 | 1′bX | 1′b1 | 1′b1 | 1′b0 | 2′d# | 1′b0 | 1′b1 |
| 1′b1 | 1′b1 | 1′b1 | 1′b0 | 1′b1 | 2′d# | 1′b1 | 1′b1 |

| | | |
|---|---|---|
| Others | N-1 | 1′b0 |

Referring to Table 6, when the BUF_SEL_CNT signal, the DL TDD signal, the UL TDD signal, the DL symbol sync signal, and the UL symbol sync signal are set as an input signal, the TDD_INDICATOR signal and the start pulse signal may be output. X may indicate ‘Don't care’. N−1 may indicate maintaining a previous value.

The multiplexer 2320 may be used to output DL traffic and UL traffic, based on the TDD_INDICATOR signal.

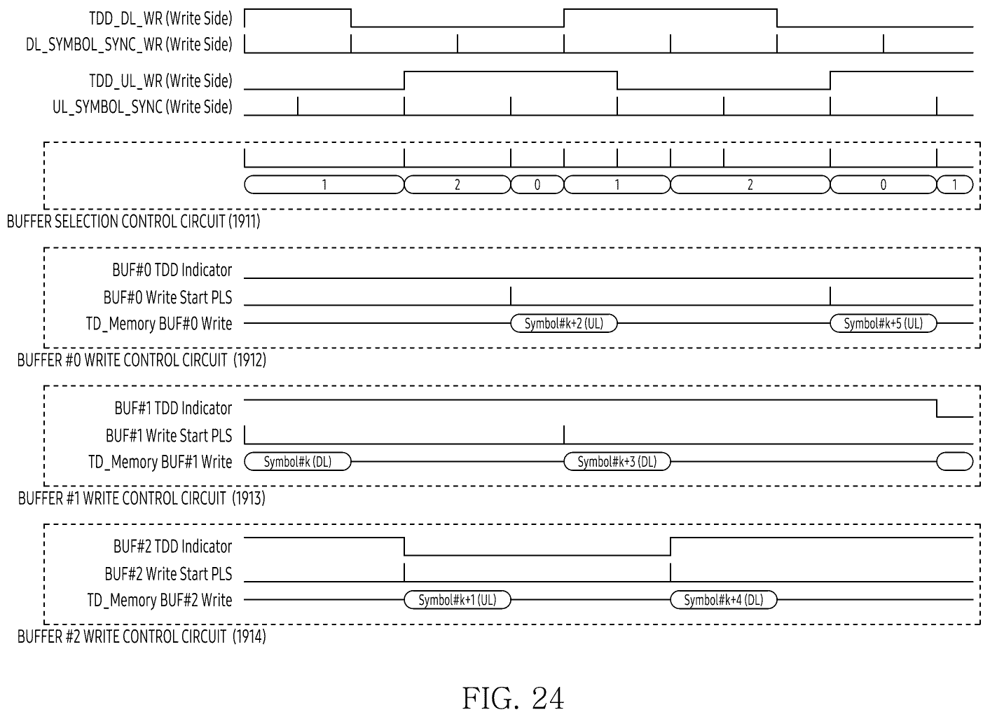

FIG. 24 is a timing diagram of signals related to circuits included in a write control circuit according to various embodiments.

Referring to FIG. 24, based on the BUF_SEL_CTRL signal, at least one of the buffer #0 write control circuit 1912, the buffer #1 write control circuit 1913, and the buffer #2 write control circuit 1914 may be indicated. Based on a value of the BUF_SEL_CTRL signal being ‘0’, traffic to be written to the buffer #0 may be output through the buffer #0 write control circuit 1912. Based on the value of the BUF_SEL_CTRL signal being ‘1’, traffic to be written to the buffer #1 may be output through the buffer #1 write control circuit 1913. Based on the value of the BUF_SEL_CTRL signal being ‘2’, traffic to be written to the buffer #2 may be output through the buffer #2 write control circuit 1914.

Each of the three buffers included in the TD memory 1100 may perform one of a DL traffic write operation and an UL traffic write operation, based on TDD_INDCACTOR signal (e.g., BUF #0_TDD_INDICATOR signal, BUF #1_TDD_INDICATOR signal, and BUF #2_TDD_INDICATOR signal). When a start pulse signal (e.g., BUF #0 start pulse (PLS) signal, BUF #1 start pulse (PLS) signal, BUF #2 start pulse (PLS) signal) is triggered, the three buffers included in the TD memory 1100 may perform the write operation for 1 symbol and then wait until the next start pulse signal.

For example, the buffer #1 write control circuit 1913 may output (or transmit) a TD_MEMORY BUF #1 write signal (e.g., BUF #Data of FIG. 23) for writing DL data according to symbol #k to the buffer #1. The buffer #2 write control circuit 1914 may output (or transmit) a TD_MEMORY BUF #2 write signal (e.g., BUF #Data of FIG. 23) for writing UL data according to symbol #k+1 to the buffer #2. The buffer #0 write control circuit 1912 may output (or transmit) a TD_MEMORY BUF #0 write signal (e.g., BUF #Data of FIG. 23) for writing UL data according to symbol #k+2 to the buffer #0. The buffer #2 write control circuit 1914 may output (or transmit) a TD_MEMORY BUF #1 write signal for writing DL data according to symbol #k+3 to the buffer #1, while the TD_MEMORY BUF #0 write signal is output. The buffer #2 write control circuit 1914 may output (or transmit) a TD_MEMORY BUF #2 write signal for writing DL data according to symbol #k+4 to the buffer #2. The buffer #0 write control circuit 1912 may output (or transmit) a TD_MEMORY BUF #0 write signal for writing UL data according to symbol #k+5 to the buffer #0.

FIG. 25 is a diagram illustrating an example configuration of a read control circuit included in TD memory according to various embodiments.

Referring to FIG. 25, a BUF_SEL_CNT signal, a DL TDD signal, a DL symbol sync signal, a UL TDD signal, a UL symbol sync signal, and a buffer #data signal (e.g., buffer #0 data signal, buffer #1 data signal, and buffer #2 data signal) may be set as an input signal of the read control circuit 1920.

A BUF #0_TDD_INDICATOR signal, a BUF #0 start pulse signal, a BUF #1_TDD_INDICATOR signal, a BUF #1 start pulse signal, a BUF #2_TDD_INDICATOR signal, a BUF #2 start pulse signal, a DL traffic and UL traffic signal may be set as an output signal of the read control circuit 1920.

The read control circuit 1920 may include a buffer selection control circuit 1921, a buffer #0 read control circuit 1922, a buffer #1 read control circuit 1923, a buffer #2 read control circuit 1924, a first multiplexer circuit 1925, and a second multiplexer circuit 1926.

The buffer selection control circuit 1921 may generate a BUF_SEL_CNT signal. The BUF_SEL_CNT signal may be used to select one of three buffers. The BUF_SEL_CNT signal may be configured with 2 bits.

The buffer #0 read control circuit 1922 may generate (or output) at least one of the BUF #0_TDD_INDICATOR signal, the BUF #0 start pulse signal, the BUF #0 DL traffic signal, and the BUF #0 UL traffic signal, based on the BUF_SEL_CNT signal, the DL TDD signal, the DL symbol sync signal, and the buffer #0 data signal.

The buffer #1 read control circuit 1923 may generate (or output) at least one of the BUF #1_TDD_INDICATOR signal, the BUF #1 start pulse signal, the BUF #1 DL traffic signal, and the BUF #1 UL traffic signal, based on the BUF_SEL_CNT signal, the DL TDD signal, the DL symbol sync signal, and the buffer #1 data signal.

The buffer #2 read control circuit 1924 may generate (or output) at least one of the BUF #2_TDD_INDICATOR signal, the BUF #2 start pulse signal, the BUF #2 DL traffic signal, and the BUF #2 UL traffic signal, based on the BUF_SEL_CNT signal, the DL TDD signal, the DL symbol sync signal, and the buffer #2 data signal.

The first multiplexer circuit 1925 may be used to output one of the BUF #0 DL traffic signal to the BUF #2 DL traffic signal as a DL traffic signal, based on the BUF_SEL_CNT signal. For example, the first multiplexer circuit 1925 may output the DL traffic signal, based on the DL TDD signal, the DL symbol sync signal, the BUF_SEL_CNT signal, the BUF #0 DL traffic signal and the BUF #2 DL traffic signal.

The second multiplexer circuit 1926 may be used to output one of the BUF #0 UL traffic signal and the BUF #2 UL traffic signal as a UL traffic signal, based on the BUF_SEL_CNT signal. For example, the first multiplexer circuit 1926 may output the UL traffic signal, based on the UL TDD signal, the UL symbol sync signal, the BUF_SEL_CNT signal, the BUF #0 UL traffic signal and the BUF #2 UL traffic signal.

The read control circuit 1920 may transmit symbol timing information and TDD information at an input time (or write time) according to DL and/or UL operation to each of the three buffers included in the TD memory 1100. The read control circuit 1920 may identify whether data read from the three buffers is DL traffic or UL traffic, based on the DL/UL timing. The read control circuit 1920 may generate DL traffic or UL traffic, which is a final output, through a DATA_SEL signal according to DL or UL generated based on the DL/UL timing. For example, the DATA_SEL signal may be generated in the first multiplexer circuit 1925 and/or the second multiplexer circuit 1926.

The buffer selection control circuit 1921 included in the read control circuit 1920 may correspond to the buffer selection control circuit 1911 of the write control circuit 1910 illustrated in FIG. 21.

The read control circuit 1920 may perform a read operation according to the DL timing and/or the UL timing. For example, the read control circuit 1920 may output DL traffic, based on DL data (or one of the BUF #0 data signal and the BUF #2 data signal) stored in one of the three buffers, at the input time according to the DL operation. For example, the read control circuit 1920 may output UL traffic, based on UL data (or one of the BUF #0 data signal and the BUF #2 data signal) stored in one of the three buffers, at the input time according to the UL operation.

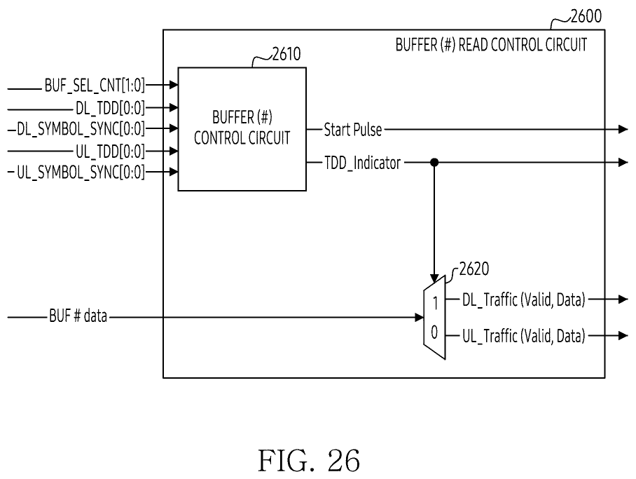

FIG. 26 is a diagram illustrating an example configuration of a buffer read control circuit included in a read control circuit according to various embodiments.

Referring to FIG. 26, a buffer (#) read control circuit 2600 may be an example of the buffer #0 read control circuit 1922, the buffer #1 read control circuit 1923, and the buffer #2 read control circuit 1924.

For example, in the buffer (#) read control circuit 2600, ‘#’ may refer to a buffer index. When ‘#’ is set to ‘0’, the buffer (#) read control circuit 2600 may operate as the buffer #0 read control circuit 1922. When ‘#’ is set to ‘1’, the buffer (#) read control circuit 2600 may operate as the buffer #1 read control circuit 1923. When ‘#’ is set to ‘2’, the buffer (#) read control circuit 2600 may operate as the buffer #2 read control circuit 1924.

The BUF_SEL_CNT signal, the DL TDD signal, the DL symbol sync signal, and the BUF #data signal may be set as an input signal of the buffer (#) read control circuit 2600.

A start pulse signal (e.g., BUF #0 start pulse signal, BUF #1 start pulse signal, and BUF #2 start pulse signal of FIG. 25), a TDD_INDICATOR signal (e.g., BUF #0_TDD_INDICATOR signal, BUF #1_TDD_INDICATOR signal, and BUF #2_TDD_INDICATOR signal of FIG. 25), a BUF (#) DL traffic signal (e.g., BUF #0 DL traffic signal, BUF #1 DL traffic signal, BUF #2 DL traffic signal of FIG. 25), and a BUF (#) UL traffic signal (e.g., BUF #0 UL traffic signal, BUF #1 UL traffic signal, BUF #2 UL traffic signal of FIG. 25) may be set as an output signal of the buffer (#) read control circuit 2600.

Based on a match of the BUF_SEL_CNT signal and the buffer index (#) (or the index of the buffer read control circuit), the buffer (#) read control circuit 2600 may generate a TDD_INDICATOR signal and a start pulse signal for each buffer using the UL TDD signal, the DL TDD signal, the UL symbol sync signal, and the DL symbol sync signal. As an example, the start pulse signal may be used to indicate a timing to start reading data stored in the buffer.

The buffer (#) read control circuit 2600 may set data read from the buffer to one of DL traffic or UL traffic, through the TDD_INDICATOR signal.

The buffer (#) read control circuit 2600 may include a buffer (#) control circuit 2610 and a multiplexer 2620.

The buffer (#) control circuit 2610 may generate (or output) the TDD_INDICATOR signal and the start pulse signal, based on a BUF_SEL_CNT signal, a DL TDD signal, a UL TDD signal, a DL symbol sync signal, and a UL symbol sync signal. The buffer (#) control circuit 2310 may operate based on the table below.

TABLE 7

| Input | | | | | | | |
|---|---|---|---|---|---|---|---|
| | DL | | UL | | | | |
| DL | symbol | UL | symbol | | | Output | |
| TDD | sync | TDD | sync | BUF_SEL_CNT_PLS | BUF_SEL_CNT | TDD_INDICATOR | Start Pulse |
| 1′b1 | 1′b1 | 1′b0 | 1′bX | 1′b1 | 2′d# | 1′b1 | 1′b1 |
| 1′b1 | 1′b0 | 1′b1 | 1′b1 | 1′b1 | 2′d# | 1′b0 | 1′b1 |
| 1′b0 | 1′bX | 1′b1 | 1′b1 | 1′b0 | 2′d# | 1′b0 | 1′b1 |
| 1′b1 | 1′b1 | 1′b1 | 1′b0 | 1′b1 | 2′d# | 1′b1 | 1′b1 |

| | | |
|---|---|---|
| Others | N-1 | 1′b0 |

Referring to Table 7, when the BUF_SEL_CNT signal, the DL TDD signal, the UL TDD signal, the DL symbol sync signal, and the UL symbol sync signal are set as an input signal, the TDD_INDICATOR signal and the start pulse signal may be output. X may refer to ‘Don't care’. N−1 may refer to maintaining a previous value.

The multiplexer 2620 may be used to output DL traffic and UL traffic, based on the TDD_INDICATOR signal.

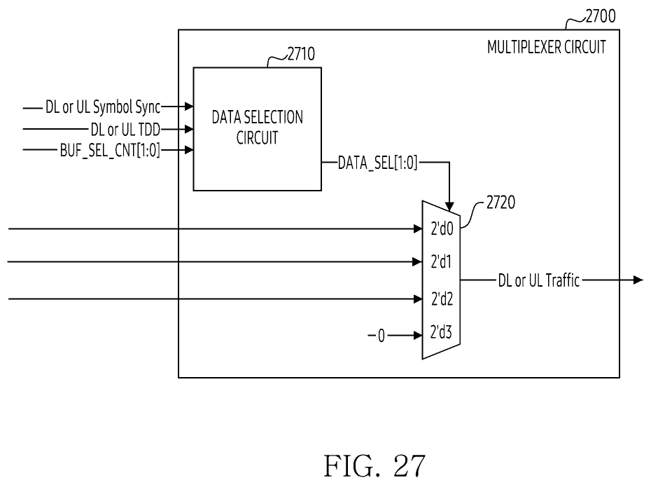

FIG. 27 is a diagram illustrating an example configuration of a multiplexer circuit included in a read control circuit according to various embodiments.

Referring to FIG. 27, a multiplexer circuit 2700 may be an example of the first multiplexer circuit 1925 and the second multiplexer circuit 1926. For example, the first multiplexer circuit 1925 may be configured for DL. The second multiplexer circuit 1926 may be configured for UL. For convenience of description, an operation of the multiplexer circuit 2700 may be described based on DL.

The multiplexer circuit 2700 may include a data selection circuit 2710 and a multiplexer 2720. The data selection circuit 2710 may identify that a DL operation is performed, based on a DL TDD signal for each DL symbol sync. The data selection circuit 2710 may output a DATA_SEL signal to have a value of a BUF_SEL_CNT signal, based on identifying that the DL operation is performed. The data selection circuit 2710 may output a DATA_SEL signal to have a value of a BUF_SEL_CNT signal and then maintain the value until the next DL symbol sync is applied. The data selection circuit 2710 may output a DATA_SEL signal to have a value of 2′d3 based on identifying that the DL operation is not performed.

Based on the DATA_SEL signal generated by the data selection circuit 2710, one of BUF #0 DL Data, BUF #1 DL Data, and BUF #2 DL Data may be selected. In a case that a value of the DATA_SEL signal is 2′d3, since it is a UL section, DL Data may be output as 0. As in the DL operation described above, the multiplexer circuit 2700 may also operate in UL based on the UL symbol sync and UL TDD signal.

For example, the data selection circuit 2710 may be used to output a DATA_SEL signal. The data selection circuit 2710 may output the DATA_SEL signal, based on a designated algorithm. The designated algorithm may be set as shown in the table below.

TABLE 8

```
if (symbol_sync = = 1′b1)
  if (tdd = = 1′b1)
    data_sel[1:0] <= buf_sel_cnt[1:0]
  else
    data_sel[1:0] <= 2′d3
else
  data_sel[1:0] <= data_sel[1:0]
```

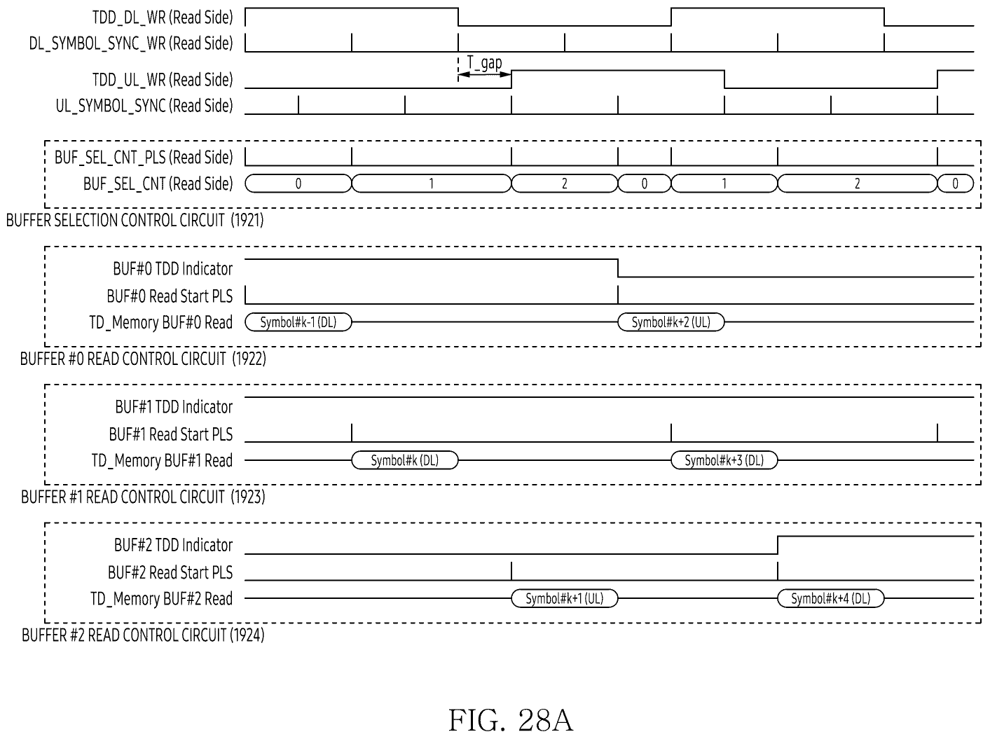

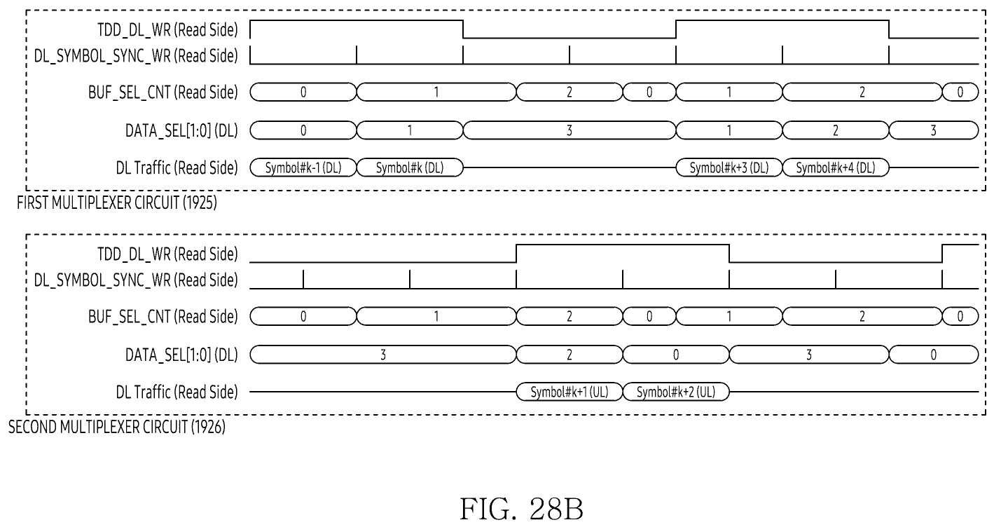

FIGS. 28A and 28B are timing diagrams of signals related to circuits included in a read control circuit according to various embodiments.

Referring to FIG. 28A and FIG. 28B, the buffer selection control circuit 1921 may generate a BUF_SEL_CNT signal. Based on the BUF_SEL_CNT signal, the buffer #0 read circuit 1922, the buffer #1 read circuit 1923, and the buffer #2 read circuit 1924 may be controlled. The buffer #0 read circuit 1922, the buffer #1 read circuit 1923, and the buffer #2 read circuit 1924 may output signals (e.g., BUF #0/1/2 TDD indicator signal, or BUF #0/1/2 read start pulse (PLS)) based on the BUF_SEL_CNT signal.

Each of the three buffers included in the TD memory 1100 may perform one of a read operation of DL data stored in the buffer and a read operation of UL data stored in the buffer, based on a TDD_INDCACTOR signal (e.g., BUF #0_TDD_INDICATOR signal, BUF #1_TDD_INDICATOR signal, and BUF #2_TDD_INDICATOR signal).

When a start pulse signal (e.g., BUF #0 start pulse (PLS) signal, BUF #1 start pulse (PLS) signal, BUF #2 start pulse (PLS) signal) is triggered, each of the three buffers included in the TD memory 1100 may perform a write operation for 1 symbol, and then wait until the next start pulse signal.

1 symbol data read from each buffer may be determined (or identified) as one of DL symbol data and UL symbol data, based on the TDD_INDCACTOR signal. The 1 symbol data determined as one of DL symbol data and UL symbol data may be finally switched based on DL/UL timing information and the DATA_SEL signal, thereby generating one of DL traffic and UL traffic.

For example, the buffer #0 read control circuit 1922, the buffer #1 read control circuit 1923, and the buffer #2 read control circuit 1924 may operate based on the BUF_SEL_CNT signal.

The buffer #0 read control circuit 1922 may output (or transmit) a TD_Memory BUF #0 read signal (e.g., the DL traffic signal of FIG. 26) to output DL data stored in the buffer #0 according to symbol #k−1. The first multiplexer circuit 1925 may output DL traffic according to symbol #k−1, based on the TD_Memory BUF #0 read signal and the BUF_SEL_CNT signal.

The buffer #1 read control circuit 1923 may output (or transmit) a TD_Memory BUF #1 read signal (e.g., the DL traffic signal of FIG. 26) to output DL data stored in the buffer #1 according to symbol #k. The first multiplexer circuit 1925 may output DL traffic according to symbol #k, based on the TD_Memory BUF #1 read signal and the BUF_SEL_CNT signal.

The buffer #2 read control circuit 1924 may output (or transmit) a TD_Memory BUF #2 read signal (e.g., the UL traffic signal of FIG. 26) to output UL data stored in the buffer #2 according to symbol #k+1. The second multiplexer circuit 1926 may output UL traffic according to symbol #k+1, based on the TD_Memory BUF #2 read signal and the BUF_SEL_CNT signal.

The buffer #0 read control circuit 1922 may output (or transmit) a TD_Memory BUF #0 read signal (e.g., the UL traffic signal of FIG. 26) to output UL data stored in the buffer #0 according to symbol #k+2. The second multiplexer circuit 1926 may output UL traffic according to symbol #k+2, based on the TD_Memory BUF #2 read signal and the BUF_SEL_CNT signal.

The buffer #1 read control circuit 1923 may output (or transmit) a TD_Memory BUF #1 read signal (e.g., the DL traffic signal of FIG. 26) to output DL data stored in the buffer #1 according to symbol #k+3, while the TD_Memory BUF #0 read signal is output. The first multiplexer circuit 1925 may output DL traffic according to symbol #k+3, based on the TD_Memory BUF #1 read signal and the BUF_SEL_CNT signal.

A configuration of the buffer circuit 1930 of the TD memory 1100 will be described.

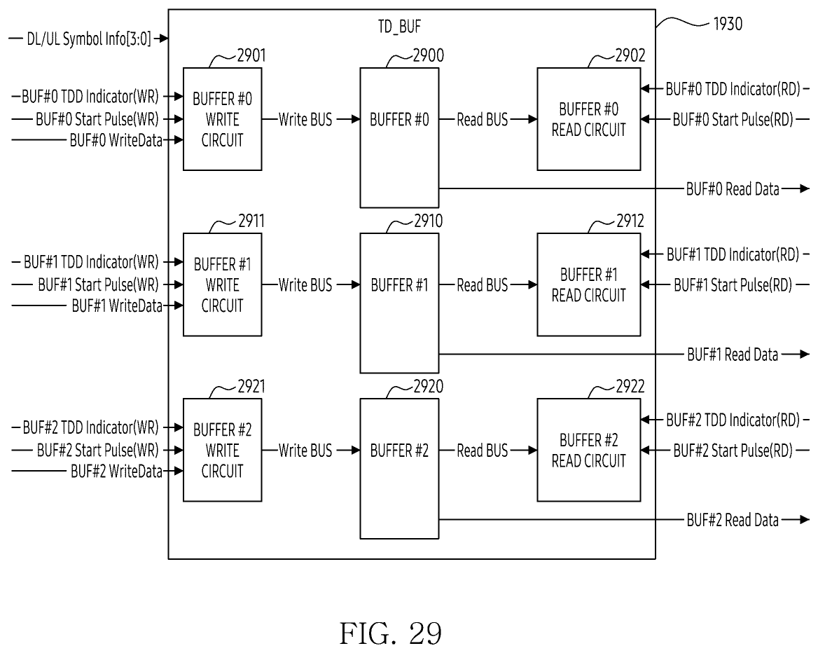

FIG. 29 is a diagram illustrating an example configuration of a buffer circuit included in TD memory according to various embodiments.

Referring to FIG. 29, the buffer circuit 1930 may include a buffer #0 2900, a buffer #1 2910, a buffer #2 2920, a buffer #0 write circuit 2901, a buffer #1 write circuit 2911, a buffer #2 write circuit 2921, a buffer #0 read circuit 2902, a buffer #1 read circuit 2912, and a buffer #2 read circuit 2922.

The buffer #0 write circuit 2901 may be connected to the buffer #0 2900, through BUS. The buffer #0 read circuit 2902 may be connected to the buffer #0 2900 through BUS.

The buffer #1 write circuit 2911 may be connected to the buffer #1 2910, through BUS. The buffer #1 read circuit 2912 may be connected to the buffer #1 2910 through BUS.

The buffer #2 write circuit 2921 may be connected to the buffer #2 2920, through BUS. The buffer #2 read circuit 2922 may be connected to the buffer #2 2920 through BUS.

The buffer circuit 1930 may receive UL/DL traffic information, symbol information, and UL/DL timing information to be written to three buffers (or symbol memories) from the buffer write control circuit 1910. Based on the received information, the three buffers may operate. In addition, the buffer circuit 1930 may receive symbol information and UL/DL timing information to read data stored in the three buffers (or symbol memories) from the buffer read control circuit 1920. Based on the received information, the buffer circuit 1930 may transmit data read from the three buffers to the buffer read control circuit 1920.

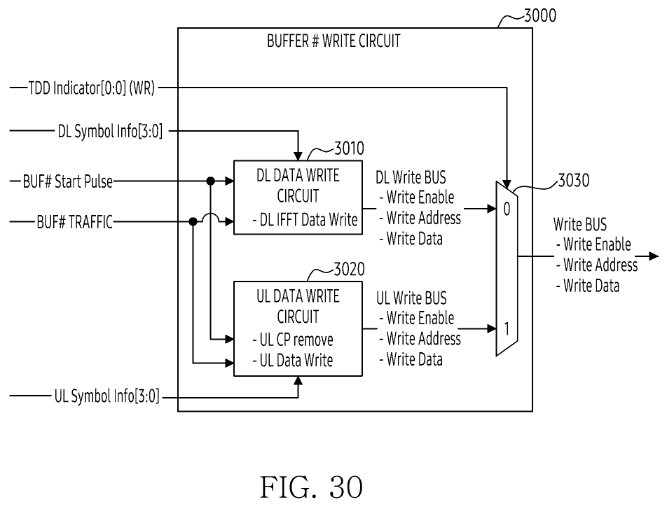

FIG. 30 is a diagram illustrating an example configuration of a buffer write circuit included in a buffer circuit according to various embodiments.

Referring to FIG. 30, a buffer (#) write circuit 3000 may be an example of the buffer #0 write circuit 2901, the buffer #1 write circuit 2911, and the buffer #2 write circuit 2921.

For example, in the buffer (#) writing circuit 3000, ‘#’ may refer to a buffer index. When ‘#’ is set to ‘0’, the buffer (#) writing circuit 3000 may operate as the buffer #0 writing circuit 2901. When ‘#’ is set to ‘1’, the buffer (#) write circuit 3000 may operate as the buffer #1 write circuit 2911. When ‘#’ is set to ‘2’, the buffer (#) write circuit 3000 may operate as a buffer #2 write circuit 2921.

The buffer (#) write circuit 3000 may include a DL data write circuit 3010, a UL data write circuit 3020, and a multiplexer 3030.

The DL data write circuit 3010 may generate write enable of buffer (or memory), address, and DL data to be written to buffer (or memory), based on receiving DL IFFT output Valid and data (e.g., write traffic signal). For example, the DL data write circuit 3010 may generate write enable of buffer (or memory), address, and DL data to be written to buffer (or memory) based on a DL symbol information signal, a start pulse signal, and a write traffic signal.

The UL data write circuit 3020 may remove UL CP, based on receiving UL IFFT output Valid and data. The UL data write circuit 3020 may generate write enable of buffer (or memory), address, and UL data to be written to buffer. For example, the UL data write circuit 3020 may generate write enable of buffer (or memory), address, and UL data to be written to buffer, based on a UL symbol information signal, a start pulse signal, and a write traffic signal.

The multiplexer 3030 may be used to output one of a signal output from the DL data write circuit 3010 and a signal output from the UL data write circuit 3020 to the outside of the buffer (#) write circuit 3000, based on a TDD_INDICATOR signal.

The DL data writing circuit 3010 and the UL data writing circuit 3020 may perform an operation corresponding to 1 symbol when a buffer is selected. The DL data writing circuit 3010 and the UL data writing circuit 3020 may determine a status of the next symbol and operate based on the status of the next symbol. For example, the DL data writing circuit 3010 and the UL data writing circuit 3020 may complete an operation corresponding to an existing symbol in a section transitioning from DL to UL or a section transitioning from UL to DL, by performing an operation corresponding to 1 symbol. The DL data writing circuit 3010 and the UL data writing circuit 3020 may perform the operation corresponding to the next symbol after completing the operation corresponding to the existing symbol.

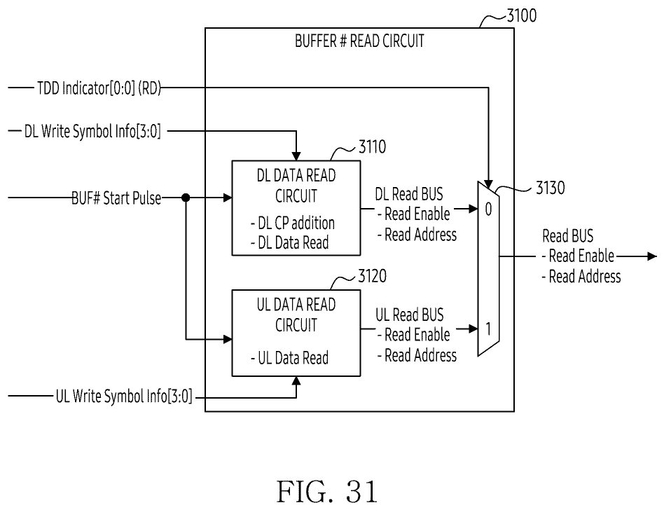

FIG. 31 is a diagram illustrating an example configuration of a buffer read circuit included in a buffer circuit according to various embodiments.

Referring to FIG. 31, the buffer (#) read circuit 3100 may be an example of the buffer #0 read circuit 2902, the buffer #1 read circuit 2912, and the buffer #2 read circuit 2922.

For example, in the buffer (#) read circuit 3100, ‘#’ may refer to a buffer index. When ‘#’ is set to ‘0’, the buffer (#) read circuit 3100 may operate as the buffer #0 read circuit 2902. When ‘#’ is set to ‘1’, the buffer (#) read circuit 3100 may operate as the buffer #1 read circuit 2912. When ‘#’ is set to ‘2’, the buffer (#) read circuit 3100 may operate as the buffer #2 read circuit 2922.

The buffer (#) read circuit 3100 may include a DL data read circuit 3110, a UL data read circuit 3120, and a multiplexer 3130.

The DL data read circuit 3110 may generate read enable of buffer (or memory) and address by considering CP insertion. For example, the DL data read circuit 3110 may generate read enable of buffer (or memory) and address, based on a DL symbol information signal and a start pulse signal.

The UL data read circuit 3120 may generate read enable of buffer (or memory) and address, according to an input interface of UL fast Fourier transform block. For example, the UL data read circuit 3120 may generate read enable of buffer (or memory) and address, based on a UL symbol information signal and a start pulse signal.

The DL data read circuit 3110 and the UL data read circuit 3120 may perform an operation corresponding to 1 symbol, when a buffer is selected. The DL data read circuit 3110 and the UL data read circuit 3120 may determine a status of the next symbol and operate based on the status of the next symbol. For example, the DL data read circuit 3110 and the UL data read circuit 3120 may complete an operation corresponding to an existing symbol in a section transitioning from DL to UL or a section transitioning from UL to DL, by performing the operation corresponding to 1 symbol. The DL data read circuit 3110 and the UL data read circuit 3120 may perform an operation corresponding to the next symbol after completing an operation corresponding to the existing symbol.

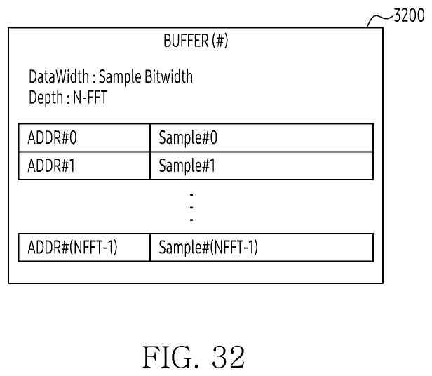

FIG. 32 is a diagram illustrating an example configuration of a buffer included in a buffer circuit according to various embodiments.

Referring to FIG. 32, a buffer (#) (or buffer (#) memory) 3200 may be an example of the buffer #0 2900, the buffer #1 2910, and the buffer #2 2920.

A size of the buffer (#) 3200 may be configured based on a bit width of one FFT (or IFFT) sample and a size of FFT. The size of the buffer (#) 3200 may be configured with the product of the bit width of one FFT (or IFFT) sample and the size of the FFT.

For example, an address for a first FFT sample (e.g., sample #0) may be set to address #0 (ADDR #0). An address for a last FFT sample (e.g., sample #(NFFT−1)) may be set to address #(NFFT−1) (ADDR #(NFFT−1)).

According to the above-described embodiments, ‘T_td_dly’ may refer to the sum of a latency from the antenna circuit 1103 to the TD memory 1100 in an UL path and a latency from the TD memory 1100 to the antenna circuit 1103 in a DL path. When ‘T_td_dly’ is smaller than T_Uadv, the above-described embodiments may be applied. Since most communication systems have ‘T_td_dly’ smaller than T_Uadv, the above-described embodiments may be applied.

For example, in a TDD system of the NR standard in which a subcarrier spacing is set to 30 kHz, a size of the FFT (NFFT) may be set to 4096 and an IQ sample bit width may be set to 30 bits. As an example, an in-phase (I) sample and a quadrature (Q) sample may be configured with signed 15 bits, respectively. In a first structure, the DL memory and the UL memory may be configured individually as shown in FIG. 10A and FIG. 10B. In a second structure, the TD memory 1100 may be configured as shown in FIG. 11. In the TDD system of the NR standard described above, the size of the required memory according to the number of antennas, the first structure, and the second structure may be set as shown in the table below.

TABLE 9

| Number of | A. First | B. Second | C. Reduction |
|---|---|---|---|
| Antenna | structure (bits) | structure (bits) | Ratio |
| 4 | 1966080 | 1474560 | 25 |
| 8 | 3932160 | 2949120 | 25 |
| 16 | 7864320 | 5898240 | 25 |
| 32 | 15728640 | 11796480 | 25 |
| 64 | 31457280 | 23592960 | 25 |

Referring to Table 9, a size of memory required in the first structure according to the number of antennas may be identified based on Equation 3 described above. A size of memory (e.g., the TD memory 1100) required in the second structure according to the number of antennas may be identified based on Equation 10 described above. The reduction rate may be identified based on Equation 11 described below.

$$C = \frac{A - B}{A} \times 100 \qquad [ Equation 11 ]$$

Referring to Equation 11, A indicates the size of memory required in the first structure of Table 8. B indicates the size of memory required in the second structure of Table 8. C indicates the reduction rate of Table 8.

As described above, when the TD memory 1100 is used, the size of the memory required to store time domain digital sample data may be reduced by 25%. As shown in Table 9, as the number of antennas and/or supported cells becomes greater and a sampling rate becomes higher, the size of the required memory may be further reduced. Accordingly, small and inexpensive components may be used, and costs required for power consumption and heat dissipation may be reduced.

According to various embodiments described above, resources required for hardware implementation may be optimized. In addition, as power consumption and the amount of heat generation of a circuit are reduced, the hardware may be miniaturized.

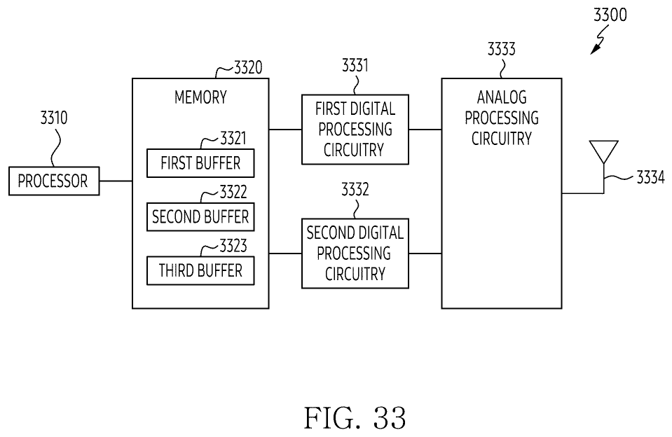

FIG. 33 is a block diagram illustrating an example configuration of an electronic device according to various embodiments.

Referring to FIG. 33, an electronic device 3300 may correspond to the RU 220 according to the various embodiments described above.

The electronic device 3300 may include at least one of a processor (e.g., including processing circuitry) 3310, memory 3320, first digital processing circuitry 3331, second digital processing circuitry 3332, analog processing circuitry 3333, and an antenna 3334.

For example, the antenna 3334 may be configured with at least one antenna. As an example, the antenna 3334 may include a patch antenna and an array antenna.

For example, the analog processing circuitry 3333 may be connected to the antenna 3334. The analog processing circuitry 3333 may include at least one of a radio frequency integrated circuit (RFIC), analog filter circuitry, and a power amplifier.

For example, the first digital processing circuitry 3331 may be connected to the analog processing circuitry 3333. The first digital processing circuitry 3331 may be used for downlink signal processing. As an example, the first digital processing circuitry 3331 may include at least one of first digital channel filter (DCF) circuitry, digital up converter (DUC) circuitry, crest factor reduction (CFR) circuitry, and digital pre-distorter (DPD) circuitry.

For example, the second digital processing circuitry 3332 may be connected to the analog processing circuitry 3333. The second digital processing circuitry 3332 may be used for uplink signal processing. As an example, the second digital processing circuitry 3332 may include at least one of the second DCF circuitry and digital downconverter (DDC) circuitry.

For example, the processor 3310 may include various processing circuitry and may be used to control at least one of the memory 3320, the first digital processing circuitry 3331, the second digital processing circuitry 3332, and the analog processing circuitry 3333. The at least one of the memory 3320, the first digital processing circuitry 3331, the second digital processing circuitry 3332, and the analog processing circuitry 3333 may be controlled by the processor 3310. As an example, the processor 3310 may transmit or receive a signal based on TDD, based on controlling the analog processing circuitry 3333.

For example, the memory 3320 may be configured to process DL samples of the first digital processing circuitry 3331 and UL samples of the second digital processing circuitry 3332. The memory 3320 may include a first buffer 3321, a second buffer 3322, and a third buffer 3323. As an example, the memory 3320 may be configured to store, within a designated time interval, first sample data for a first symbol, second sample data for a second symbol, and third symbol data for a third symbol. The number of samples included in each of the first sample data, the second sample data, and the third sample data may be set based on the size for FFT and IFFT.

For example, the first sample data may include input data for a fast Fourier transform (FFT) for the first symbol. The second sample data may include output data for an inverse fast Fourier transform (IFFT) for the second symbol. The third sample data may include one of input data for the FFT and output data for the IFFT for the third symbol.

For example, the first symbol, the second symbol, and the third symbol may be configured based on TDD. A time interval during which the first symbol is received through an antenna may be distinguished from a time interval during which the second symbol is transmitted through an antenna. The time interval during which the first symbol is received through the antenna may be distinguished from a time interval during which the third symbol is transmitted and/or received. The time interval during which the second symbol is transmitted through the antenna may be distinguished from the time interval during which the third symbol is transmitted and/or received.

According to an embodiment, the first symbol may be followed by the third symbol based on TDD. The third symbol may be followed by the second symbol based on TDD. For example, the third sample data may be set as input data for FFT for the third symbol. When the third sample data is set as input data for FFT for the third symbol, the first sample data may be output from the memory 3320 within a designated time interval. The second sample data may be input into the memory 3320 within a designated time interval. The third sample data may be output from the memory 3320 within a designated time interval. For example, the third sample data may be set as output data for IFFT for the third symbol. When the third sample data is set as output data for IFFT for the third symbol, the first sample data may be output from the memory 3320 within a designated time interval. The second sample data may be input into the memory 3320 within a designated time interval. The third sample data may be input into the memory 3320 within a designated time interval.

According to an embodiment, the second symbol may be followed by the third symbol based on TDD. The third symbol may be followed by the first symbol based on TDD. For example, the third sample data may be set as input data for FFT for the third symbol. When the third sample data is set as input data for FFT for the third symbol, the first sample data may be output from the memory 3320 within a designated time interval. The second sample data may be input into the memory 3320 within a designated time interval. The third sample data may be output from the memory 3320 within a designated time interval. For example, the third sample data may be set as output data for IFFT for the third symbol. When the third sample data is set as output data for IFFT for the third symbol, the first sample data may be output from the memory 3320 within a designated time interval. The second sample data may be input into the memory 3320 within a designated time interval. The third sample data may be input into the memory 3320 within a designated time interval.

Although not illustrated, the memory 3320 may include a write control circuit (e.g., the write control circuit 1910 of FIG. 19), a read control circuit (e.g., the read control circuit 1920 of FIG. 19), and a buffer circuit (e.g., the buffer circuit 1930 of FIG. 19). The first buffer 3321, the second buffer 3322, and the third buffer 3323 may be included in the buffer circuit.

For example, the write control circuit may include a first buffer selection control circuit (e.g., the buffer selection control circuit 1911 of FIG. 21), a first buffer write control circuit (e.g., the buffer #0 write control circuit 1912 of FIG. 21), a second buffer write control circuit (e.g., the buffer #1 write control circuit 1913 of FIG. 21), and a third buffer write control circuit (e.g., the buffer #2 write control circuit 1914 of FIG. 21). The first buffer write control circuit may be used to write data to a first buffer included in the buffer circuit. The second buffer write control circuit may be used to write data to a second buffer included in the buffer circuit. The third buffer write control circuit may be used to write data to a third buffer included in the buffer circuit.

For example, the read control circuit may include at least one of a second buffer selection control circuit (e.g., the buffer selection control circuit 1921 of FIG. 25), a first buffer read control circuit (e.g., the buffer #0 read control circuit 1922 of FIG. 25), a second buffer read control circuit (e.g., the buffer #1 read control circuit 1923 of FIG. 25), a third buffer read control circuit (e.g., the buffer #2 read control circuit 1924 of FIG. 25), a first multiplexer circuit, and a second multiplexer circuit. The first buffer read control circuit may be used to read data stored in the first buffer 3321. The second buffer read control circuit may be used to read data stored in the second buffer 3322. The third buffer read control circuit may be used to read data stored in the third buffer 3323.

For example, the buffer circuit may include the first buffer 3321, the second buffer 3322, the third buffer 3323, and a plurality of link selection circuits. The plurality of link selection circuits may control buffers based on one of uplink and downlink.

Among the plurality of link selection circuits, a first link selection circuit (e.g., the buffer #0 write circuit 2901 of FIG. 29), a second link selection circuit (e.g., the buffer #1 write circuit 2911 of FIG. 29), and a third link selection circuit (e.g., the buffer #2 write circuit 2921 of FIG. 29) may be used to write data regarding one of the DL samples and the UL samples.

Among the plurality of link selection circuits, a fourth link selection circuit (e.g., the buffer #0 read circuit 2902 of FIG. 29), a fifth link selection circuit (e.g., the buffer #1 read circuit 2912 of FIG. 29), and a sixth link selection circuit (e.g., the buffer #2 read circuit 2922 of FIG. 29) may be used for reading data regarding one of the DL samples and the UL samples.

The first link selection circuit and the fourth link selection circuit may be configured to control a path for the first buffer 3321. The first link selection circuit may activate a BUS for writing data to the first buffer 3321. The fourth link selection circuit may activate a BUS for reading data from the first buffer 3321.

The second link selection circuit and the fifth link selection circuit may be configured to control a path for the second buffer 3322. The second link selection circuit may activate a BUS for writing data to the second buffer 3322. The fifth link selection circuit may activate a BUS for reading data from the second buffer 3322.

The third link selection circuit and the sixth link selection circuit may be configured to control a path for the third buffer 3323. The third link selection circuit may activate a BUS for writing data to the third buffer 3323. The sixth link selection circuit may activate a BUS for reading data from the third buffer 3323.

Although not illustrated, the electronic device 3300 may further include frequency domain signal processing circuitry. The first sample data may be converted into first UL data of a frequency domain, based on a Fourier transform.

For example, the processor 3310 may convert the first UL data into second UL data through the frequency domain signal processing circuitry. The processor 3310 may transmit the second UL data to an external electronic device (e.g., the DU 210) including a modem.

For example, the processor 3310 may receive the first DL data from an external electronic device (e.g., the DU 210) including a modem. The processor 3310 may convert the first DL data into second DL data through the frequency domain signal processing circuitry. The second DL data may be converted into second sample data based on IFFT. The processor 3310 may set a portion of the second sample data as CP for downlink.

For example, the processor 3310 may store first sample data for a first symbol in the first buffer 3321 included in the memory 3320, within a designated time interval. The processor 3310 may store second sample data for a second symbol in the second buffer 3322 included in the memory 3320, within a specified time interval. The processor 3310 may store third sample data for a third symbol in the third buffer 3323 included in the memory 3320, within a designated time interval. As an example, the first symbol may be followed by the second symbol. The second symbol may be followed by the third symbol.

According to an example embodiment, an electronic device (e.g., the RU 220) may comprise an antenna, analogue processing circuitry connected to the antenna, first digital processing circuitry for a downlink (DL) signal processing, connected to the analogue processing circuitry, second digital processing circuitry for an uplink (UL) signal processing, connected to the analogue processing circuitry, a processor, and memory configured to process DL samples of the first digital processing circuitry and UL samples of the second digital processing circuitry. The memory may be configured to store, in a designated time interval, first sample data for a first symbol, second sample data for a second symbol, and third sample data for a third symbol. The first sample data may comprise input data for a fast Fourier transform (FFT) for the first symbol.

The second sample data may comprise output data for an inverse fast Fourier transform (IFFT) for the second symbol. The third sample data may comprise one of input data for the FFT for the third symbol and output data for the inverse fast Fourier transform (IFFT) for the third symbol. The first symbol, the second symbol, and the third symbol may be configured based on a time division duplex (TDD).

According to an embodiment, the analogue processing circuitry may comprise at least one of a radio frequency integrated circuit (RFIC), analogue filter circuitry, and a power amplifier.

According to an embodiment, the first digital processing circuitry may comprise at least one of first digital channel filter (DCF) circuitry, digital up converter (DUC) circuitry, crest factor reduction (CFR) circuitry, and digital pre-distorter (DPD) circuitry.

According to an embodiment, the second digital processing circuitry may comprise at least one of second DCF circuitry and digital down converter (DDC) circuitry.

According to an embodiment, the memory may comprise a write control circuit, a read control circuit, and a buffer circuit.

According to an embodiment, the write control circuit may include a first buffer selection control circuit, a first buffer write control circuit, a second buffer write control circuit, and a third buffer write control circuit. The first buffer write control circuit may be used for writing data to a first buffer included in the buffer circuit. The second buffer write control circuit may be used for writing data to a second buffer included in the buffer circuit. The third buffer write control circuit may be used for writing data to a third buffer included in the buffer circuit.

According to an embodiment, the read control circuit may include a second buffer selection control circuit, a first buffer read control circuit, a second buffer read control circuit, and a third buffer read control circuit. The first buffer read control circuit may be used for reading data stored in the first buffer. The second buffer read control circuit may be used for reading data stored in the second buffer. The third buffer read control circuit may be used for reading data stored in the third buffer.

According to an embodiment, the buffer circuit may include the first buffer, the second buffer, the third buffer, and a plurality of link selection circuits. A first link selection circuit, a second link selection circuit, and a third link selection circuit among the plurality of link selection circuits, may be used for writing data related to one of the DL samples and the UL samples. A fourth link selection circuit, a fifth link selection circuit, and a sixth link selection circuit among the plurality of link selection circuits, may be used for reading the data related to one of the DL samples and the UL samples.

According to an embodiment, the first link selection circuit and the fourth link selection circuit may be configured to control a path for the first buffer. The second link selection circuit and the fifth link selection circuit may be configured to control a path for the second buffer. The third link selection circuit and the sixth link selection circuit may be configured to control a path for the third buffer.

According to an embodiment, the electronic device may further comprise frequency domain signal processing circuitry.

According to an embodiment, the first sample data may be converted, based on the FFT, to first UL data of frequency domain. The processor may be configured to convert, through the frequency domain signal processing circuitry, the first UL data to second UL data. The processor may be configured to transmit, to an external electronic device comprising a modem, the second UL data.

According to an embodiment, the processor may be further configured to receive, from the external electronic device comprising the modem, first DL data. The processor may be further configured to convert, through the frequency domain signal processing circuit, the first DL data to second DL data. The second DL data may be converted to the second sample data based on the IFFT.

According to an embodiment, the processor may be configured to set a portion of the second sample data as cyclic prefix for downlink.

According to an embodiment, the first symbol may be followed by the third symbol based on the TDD. The third symbol may be followed by the second symbol based on the TDD.

According to an embodiment, the third sample data may be set as input data for the FFT for the third symbol. The first sample data may be output from the memory within the designated time interval. The second sample data may be input into the memory within the designated time interval. The third sample data may be output from the memory within the designated time interval.

According to an embodiment, the third sample data may be set as output data for the IFFT for the third symbol. The first sample data may be output from the memory within the designated time interval. The second sample data may be input into the memory within the designated time interval. The third sample data may be input into the memory within the designated time interval.

According to an embodiment, the second symbol may be followed by the third symbol based on the TDD. The third symbol may be followed by the first symbol based on the TDD.

According to an embodiment, the third sample data may be set as input data for the FFT for the third symbol. The first sample data may be output from the memory within the designated time interval. The second sample data may be input into the memory within the designated time interval. The third sample data may be output from the memory within the designated time interval.

According to an embodiment, the third sample data may be set as output data for the IFFT for the third symbol. The first sample data may be output from the memory within the designated time interval. The second sample data may be input into the memory within the designated time interval. The third sample data may be input into the memory within the designated time interval.

According to an embodiment, the number of samples included in each of the first sample data, the second sample data, and the third sample data may be set based on the sizes of the FFT and the IFFT.

According to an example embodiment, an electronic device (e.g., RU 220) comprise an antenna, analogue processing circuitry connected to the antenna, first digital processing circuitry for a downlink (DL) signal processing, connected to the analogue processing circuitry, second digital processing circuitry for an uplink (UL) signal processing, connected to the analogue processing circuitry, memory configured to process DL samples of the first digital processing circuitry and UL samples of the second digital processing circuitry, and a processor. The processor may be configured to, in a designated time interval, store first sample data for a first symbol to a first buffer included in the memory, store second sample data for a second symbol to a second buffer included in the memory, and output third sample data for a third symbol from a third buffer included in the memory. The first symbol, and the second symbol, and the third symbol may be configured based on a time division duplex (TDD). The first symbol may be followed by the second symbol. The second symbol may be followed by the third symbol.

Methods according to various embodiments described in the present disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in the present disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), an optical storage device (digital versatile discs (DVDs) or other formats), or a magnetic cassette. It may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the present disclosure through an external port. In addition, a separate storage device on the communication network may also be connected to a device performing an embodiment of the present disclosure.

In the above-described example embodiments of the present disclosure, components included in the disclosure are expressed in the singular or plural according to the presented specific embodiment. However, the singular or plural expression is selected appropriately according to a situation presented for convenience of explanation, and the present disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

Meanwhile, various example embodiments have been described in the detailed description of the present disclosure, and of course, various modifications are possible without departing from the scope of the present disclosure. It will also be understood that any of the embodiment(s) described herein may be used in conjunction with any other embodiment(s) described herein.

What is claimed is:

1. An electronic device comprising:
an antenna;
analogue processing circuitry connected to the antenna;
first digital processing circuitry configured for a downlink (DL) signal processing, connected to the analogue processing circuitry;
second digital processing circuitry configured for an uplink (UL) signal processing, connected to the analogue processing circuitry;
at least one processor comprising processing circuitry; and
memory configured to process DL samples of the first digital processing circuitry and UL samples of the second digital processing circuitry,
wherein the memory is configured to store, in a designated time interval, first sample data for a first symbol, second sample data for a second symbol, and third sample data for a third symbol,
wherein the first sample data comprises input data for a fast Fourier transform (FFT) for the first symbol,
wherein the second sample data comprises output data for an inverse fast Fourier transform (IFFT) for the second symbol,
wherein the third sample data comprises one of input data for the FFT for the third symbol and output data for the inverse fast Fourier transform (IFFT) for the third symbol, and
wherein the first symbol, the second symbol, and the third symbol are configured based on a time division duplex (TDD).

2. The electronic device of claim 1, wherein the analogue processing circuitry comprises at least one of a radio frequency integrated circuit (RFIC), analogue filter circuitry, and a power amplifier.

3. The electronic device of claim 1, wherein the first digital processing circuitry comprises at least one of first digital channel filter (DCF) circuitry, digital up converter (DUC) circuitry, crest factor reduction (CFR) circuitry, and digital pre-distorter (DPD) circuitry.

4. The electronic device of claim 1, wherein the second digital processing circuitry comprises at least one of second DCF circuitry and digital down converter (DDC) circuitry.

5. The electronic device of claim 1, wherein the memory comprises a write control circuit, a read control circuit, and a buffer circuit.

6. The electronic device of claim 5, wherein the write control circuit includes:
a first buffer selection control circuit;
a first buffer write control circuit;
a second buffer write control circuit; and
a third buffer write control circuit;
wherein the first buffer write control circuit is configured to write data to a first buffer included in the buffer circuit,
wherein the second buffer write control circuit configured to write data to a second buffer included in the buffer circuit, and
wherein the third buffer write control circuit is configured to write data to a third buffer included in the buffer circuit.

7. The electronic device of claim 6, wherein the read control circuit includes:
a second buffer selection control circuit;
a first buffer read control circuit;
a second buffer read control circuit; and
a third buffer read control circuit;
wherein the first buffer read control circuit is configured to read data stored in the first buffer,
wherein the second buffer read control circuit is configured to read data stored in the second buffer, and
wherein the third buffer read control circuit is configured to read data stored in the third buffer.

8. The electronic device of claim 7, wherein the buffer circuit includes:
the first buffer;
the second buffer;
the third buffer; and
a plurality of link selection circuits,
wherein a first link selection circuit, a second link selection circuit, and a third link selection circuit among the plurality of link selection circuits, are configured to write data related to one of the DL samples and the UL samples, and
wherein a fourth link selection circuit, a fifth link selection circuit, and a sixth link selection circuit among the plurality of link selection circuits, are configured to read the data related to one of the DL samples and the UL samples.

9. The electronic device of claim 8, wherein the first link selection circuit and the fourth link selection circuit are configured to control a path for the first buffer,
wherein the second link selection circuit and the fifth link selection circuit are configured to control a path for the second buffer, and
wherein the third link selection circuit and the sixth link selection circuit are configured to control a path for the third buffer.

10. The electronic device of claim 1, wherein the electronic device further comprises frequency domain signal processing circuitry.

11. The electronic device of claim 10, wherein the first sample data is converted, based on the FFT, to first UL data of frequency domain,
wherein at least one processor, individually and/or collectively, is configured to cause the electronic device to:
convert, through the frequency domain signal processing circuitry, the first UL data to second UL data, and
transmit, to an external electronic device comprising a modem, the second UL data.

12. The electronic device of claim 11, wherein at least one processor, individually and/or collectively, is configured to cause the electronic device to:
receive, from the external electronic device comprising the modem, first DL data, and
convert, through the frequency domain signal processing circuit, the first DL data to second DL data, and
wherein the second DL data is converted to the second sample data based on the IFFT.

13. The electronic device of claim 12, wherein at least one processor, individually and/or collectively, is configured to cause the electronic device to set a portion of the second sample data as cyclic prefix for downlink.

14. The electronic device of claim 1, wherein the first symbol is followed by the third symbol based on the TDD, and
wherein the third symbol is followed by the second symbol based on the TDD.

15. The electronic device of claim 14, wherein the third sample data is set as input data for the FFT for the third symbol,
wherein the first sample data is output from the memory within the designated time interval,
wherein the second sample data is input into the memory within the designated time interval, and
wherein the third sample data is output from the memory within the designated time interval.

16. The electronic device of claim 14, wherein the third sample data is set as output data for the IFFT for the third symbol,
wherein the first sample data is output from the memory within the designated time interval,
wherein the second sample data is input into the memory within the designated time interval, and
wherein the third sample data is input into the memory within the designated time interval.

17. The electronic device of claim 1, wherein the second symbol is followed by the third symbol based on the TDD, and
wherein the third symbol is followed by the first symbol based on the TDD.

18. The electronic device of claim 17, wherein, the third sample data is set as input data for the FFT for the third symbol,
wherein the first sample data is output from the memory within the designated time interval,
wherein the second sample data is input into the memory within the designated time interval, and
wherein the third sample data is output from the memory within the designated time interval.

19. The electronic device of claim 17, wherein the third sample data is set as output data for the IFFT for the third symbol,
wherein the first sample data is output from the memory within the designated time interval,
wherein the second sample data is input into the memory within the designated time interval, and
wherein the third sample data is input into the memory within the designated time interval.

20. An electronic device comprising:
an antenna;
analogue processing circuitry connected to the antenna;
first digital processing circuitry configured for a downlink (DL) signal processing, connected to the analogue processing circuitry;
second digital processing circuitry configured for an uplink (UL) signal processing, connected to the analogue processing circuitry;
memory configured to process DL samples of the first digital processing circuitry and UL samples of the second digital processing circuitry; and
at least one processor, comprising processing circuitry, individually and/or collectively, configured to cause the electronic device to:
in a designated time interval:
store first sample data for a first symbol to a first buffer included in the memory,
store second sample data for a second symbol to a second buffer included in the memory, and
output third sample data for a third symbol from a third buffer included in the memory,
wherein the first symbol, and the second symbol, and the third symbol are configured based on a time division duplex (TDD),
wherein the first symbol is followed by the second symbol, and
wherein the second symbol is followed by the third symbol.
